(19) United States
(12) Patent Application Publication
(10) Pub. No.: US 2026/0046789 A1
(43) Pub. Date: Feb. 12, 2026

(54) DUPLEX SPECIFIC POWER CONTROL AND UNIFIED TCI FRAMEWORK

(71) Applicant: QUALCOMM Incorporated, San Diego, CA (US)

(72) Inventors: Muhammad Sayed Khairy ABDELGHAFFAR, San Jose, CA (US); Yan ZHOU, San Diego, CA (US); Qian ZHANG, Basking Ridge, NJ (US); Wanshi CHEN, San Diego, CA (US)

(21) Appl. No.: 18/798,794

(22) Filed: Aug. 8, 2024

(51) Int. Cl. H04W 52/42; H04L 5/00; H04W 52/14; H04W 88/06

(52) U.S. Cl. CPC H04W 52/42; H04L 5/0053; H04L 5/0096; H04W 52/146; H04W 88/06

(57) ABSTRACT

Duplex-specific power control for a unified TCI framework is described. An apparatus may be configured to receive, from a network node, a TCI configuration indicative of at least one set of TCI states information. Each TCI state in the at least one set of TCI states information includes UL PC parameters associated with a SBFD operational mode or with a non-SBFD operational mode. The apparatus may be configured to activate one or more TCI states from a set of TCI states associated with the UL PC parameters in accordance with the at least one set of TCI states information. The apparatus may be configured to transmit, to the network node via a set of beams associated with the activated one or more TCI states, UL messages in accordance with an UL PC parameter of a TCI state that is based on the set of TCI states.

### TECHNICAL FIELD

The present disclosure relates generally to communication systems, and more particularly, to wireless communications utilizing transmission configuration indication (TCI) states information.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE), and the method may be performed at, or by, the UE. The apparatus is configured to receive, from a network node, a transmission configuration indication (TCI) configuration indicative of at least one set of TCI states information, where each TCI state in the at least one set of TCI states information includes uplink (UL) power control (PC) parameters associated with a sub-band (SB) full duplex (SBFD) operational mode or with a non-SBFD operational mode. The apparatus is configured to activate one or more TCI states from a set of TCI states associated with the UL PC parameters in accordance with the at least one set of TCI states information. The apparatus is configured to transmit, to the network node via a set of beams associated with the activated one or more TCI states, UL messages in accordance with an UL PC parameter of a TCI state that is based on the set of TCI states.

In the aspect, the method includes receiving, from a network node, a TCI configuration indicative of at least one set of TCI states information, where each TCI state in the at least one set of TCI states information includes UL PC parameters associated with a SBFD operational mode or with a non-SBFD operational mode. The method includes activating one or more TCI states from a set of TCI states associated with the UL PC parameters in accordance with the at least one set of TCI states information. The method includes transmitting, to the network node via a set of beams associated with the activated one or more TCI states, UL messages in accordance with an UL PC parameter of a TCI state that is based on the set of TCI states.

In the aspect, the computer readable medium stores computer executable code at a UE, the code when executed by at least one processor causes the at least one processor to receive, from a network node, a TCI configuration indicative of at least one set of TCI states information, where each TCI state in the at least one set of TCI states information includes UL PC parameters associated with a SBFD operational mode or with a non-SBFD operational mode. The code when executed by at least one processor causes the at least one processor to activate one or more TCI states from a set of TCI states associated with the UL PC parameters in accordance with the at least one set of TCI states information. The code when executed by at least one processor causes the at least one processor to transmit, to the network node via a set of beams associated with the activated one or more TCI states, UL messages in accordance with an UL PC parameter of a TCI state that is based on the set of TCI states.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of medium access control (MAC) control element (MAC-CE) activation for TCI codepoints.

FIG. 5 is a call flow diagram for wireless communications, in accordance with various aspects of the present disclosure.

FIG. 6 is a diagram illustrating an example of configuration and activation for TCI codepoints associated with PC parameters for separate sets of duplex-specific TCI states, in accordance with various aspects of the present disclosure.

FIG. 7 is a diagram illustrating an example of configuration and activation for TCI codepoints associated with PC parameters for a joint set of duplex-specific TCI states, in accordance with various aspects of the present disclosure.

FIG. 8 is a diagram illustrating an example of configuration and activation for TCI codepoints associated with PC parameters for a shared set of duplex-specific TCI states, in accordance with various aspects of the present disclosure.

FIG. 9 is a diagram illustrating an example of configuration and activation for TCI codepoints associated with PC parameters for a shared set of duplex-specific TCI states, in accordance with various aspects of the present disclosure.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network entities (e.g., network nodes such as base stations, eNBs, gNBs, etc.; entities in a core network) and UEs. In some aspects, a UE may be configured by a network node for unified TCI states to be utilized in communications. As an example, a radio resource control (RRC) configuration from a network node indicates whether the unified TCI is for joint DL/UL or separate UL/DL TCI states. Subsequently, a MAC-CE activates up to 8 TCI codepoints where each TCI codepoint has up-to two TCI states. In case of separate DL/UL unified TCI, each TCI codepoint is mapped to one DL TCI state, or one UL TCI state, or One DL TCI state and one UL TCI state. In case of joint DL/UL unified TCI, each TCI codepoint can be mapped to one joint DL/UL TCI state. Downlink control information (DCI) format 1_1/1_2 indicates one of the TCI codepoints as “sticky” TCI codepoint till the UE receives another DCI indication. PC parameters are configured per the TCI-state definition (e.g., have separate instances for configurations in UL-only or joint UL/DL TCI) and include path loss reference signal (PL-RS) and PC parameters (e.g., Po, alpha, closed-loop index, and/or the like). The PC parameters may be configured for signaling in a physical uplink shared channel (PUSCH), physical uplink control channel (PUCCH), sounding reference signals (SRS), etc.

However, current TCI state configurations lack support of separate UL power control for PUSCH, PUCCH, SRS, etc., transmissions in SBFD symbols and non-SBFD symbols. That is, while solutions provide for unified TCI state frameworks, as noted above, such frameworks do not enable a network node to configure a UE for duplex-specific power control for such unified TCI frameworks. Accordingly, nor do current solutions enable the configuration of a UE with separate PC parameters for duplex-specific power control.

Various aspects relate generally to wireless communications utilizing TCI states information. Some aspects more specifically relate to duplex-specific power control for a unified TCI framework. In some examples, a UE may receive, from a network node, a TCI configuration indicative of a set(s) of TCI states information. The set(s) of TCI states information may include PC parameters associated with a SBFD operational mode and with a non-SBFD operational mode. The UE may be activated with a TCI codepoint(s) and associated with the PC parameters of the TCI state(s), e.g., in accordance with the set(s) of TCI states information. The UE may then transmit, to the network node (e.g., via a beam(s) of the TCI state(s)), UL messages (or signals/channels) in accordance a PC parameter of a TCI state that is based on the TCI state(s) and the TCI codepoint(s). Accordingly, separate, joint, and/or shared sets of configured and/or activated TCI codepoints and associated TCI states, per duplex type, are enabled by aspects herein.

Particular aspects of the subject matter described in this disclosure can be implemented to realize one or more of the following potential advantages. In some examples, by providing TCI configurations for duplex-specific power control, the described techniques can be used to enable separate UL power control in SBFD symbols and in non-SBFD symbols. In some examples, by enabling flexibility in such TCI configurations for duplex-specific power control, the described techniques can be used to enable duplex-specific power control for a unified TCI framework in different operating scenarios. In some examples, by providing duplex-specific indications in a MAC-CE and/or DCI, the described techniques can be used to enable the configuration of a UE with separate PC parameters. In other examples, may by providing different pools or sets of unified TCI states for each duplex type via a semi-static configuration, the described techniques can be used to enable configuration of the duplex-specific PC parameters.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

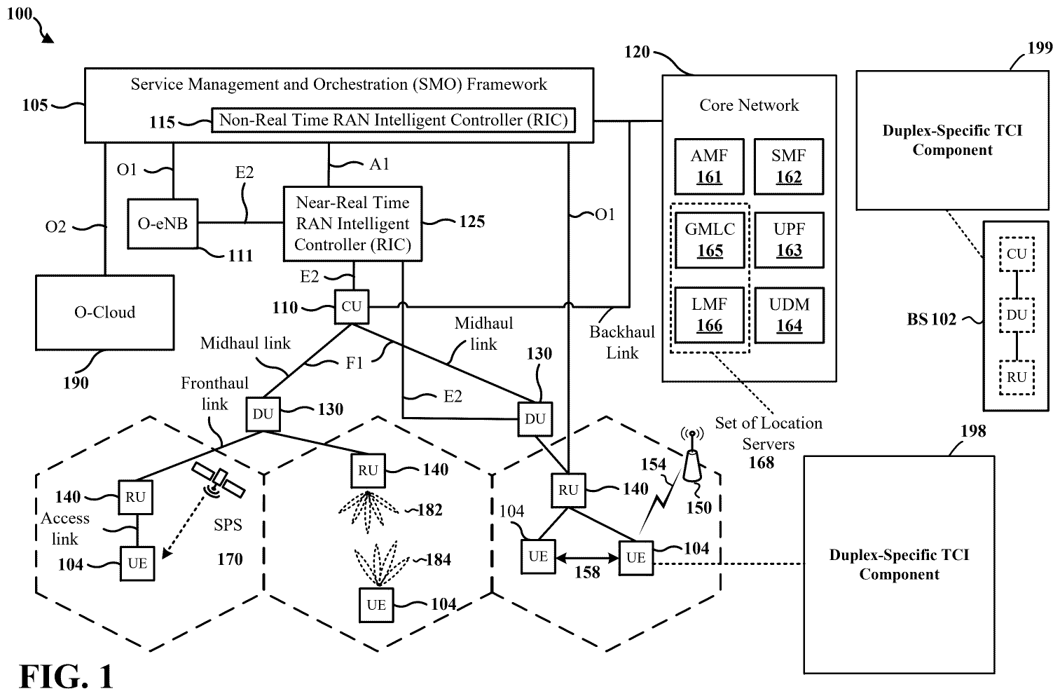

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-cNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a duplex-specific TCI component 198 (“component 198”) that may be configured to receive, from a network node, a TCI configuration indicative of at least one set of TCI states information, where each TCI state in the at least one set of TCI states information includes UL PC parameters associated with a SBFD operational mode or with a non-SBFD operational mode. The component 198 may be configured to activate one or more TCI states from a set of TCI states associated with the UL PC parameters in accordance with the at least one set of TCI states information. The component 198 may be configured to transmit, to the network node via a set of beams associated with the activated one or more TCI states, UL messages in accordance with an UL PC parameter of a TCI state that is based on the set of TCI states. In certain aspects, the base station 102 may have duplex-specific TCI component 199 (“component 199”) that may be configured to configure a UE with a TCI configuration indicative of at least one set of TCI states information, where the at least one set of TCI states information includes UL PC parameters associated with a SBFD operational mode or with a non-SBFD operational mode. The component 199 may be configured to receive, from the UE via a set of beams and subsequent to activation of one or more TCI states from a set of TCI states associated with the UL PC parameters, UL messages in accordance with an UL PC parameter of a TCI state that is based on the set of TCI states.

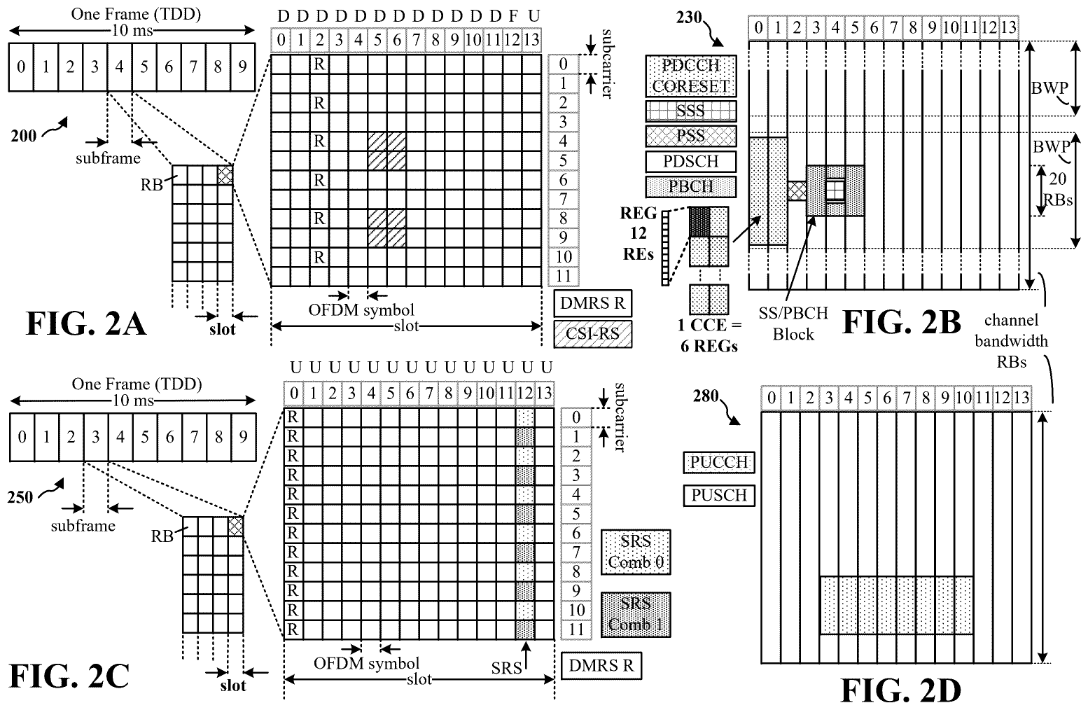

Aspects provide for enabling separate UL power control in SBFD symbols and in non-SBFD symbols by providing TCI configurations for duplex-specific power control, enabling duplex-specific power control for a unified TCI framework in different operating scenarios by enabling flexibility in such TCI configurations for duplex-specific power control, and enabling the configuration of a UE with separate PC parameters by providing duplex-specific indications in a MAC-CE and/or DCI. Accordingly, separate, joint, and/or shared sets of configured and/or activated TCI states and associated TCI codepoints, per duplex type, are enabled by aspects herein. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

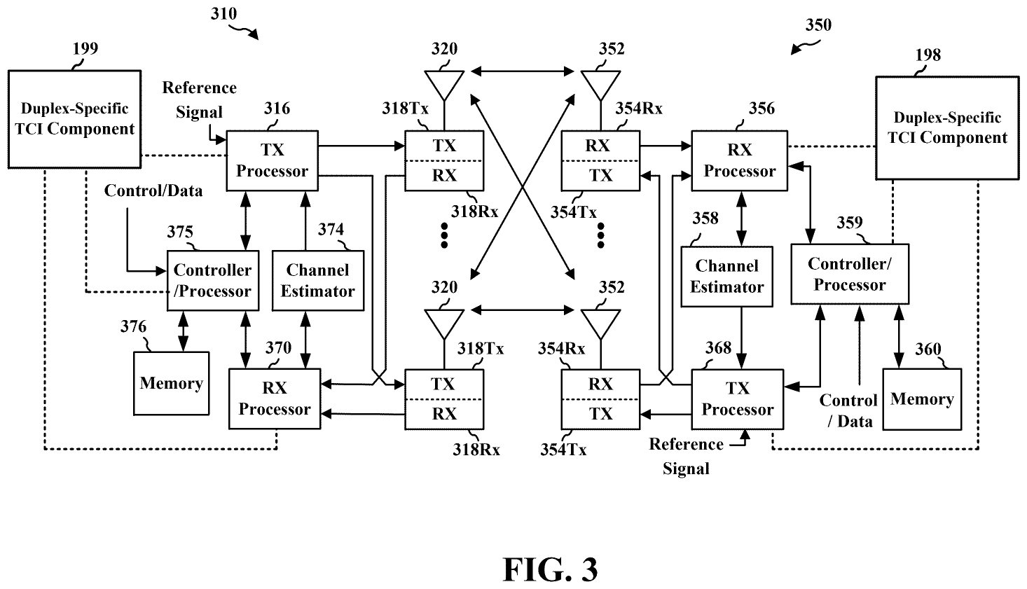

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE may be configured by a network node for unified TCI states to be utilized in communications. As an example, a RRC configuration from a network node indicates whether the unified TCI is for joint DL/UL or separate UL/DL TCI states.

Subsequently, a MAC-CE activates unified TCI states and indicates whether the TCI codepoint has two TCI states, e.g., separate UL/DL TCI, or single TCI states, e.g., joint UL/DL TCI, UL-only UL/DL TCI, or DL-only UL/DL TCI. Downlink control information (DCI) format 1_1/1_2 has TCI states that indicate these “sticky” TCI codepoints. PC parameters are configured per the TCI-state definition (e.g., have separate instances for configurations in UL-only or joint UL/DL TCI) and include PL-RS and PC parameters (e.g., Po, alpha, closed-loop index, and/or the like). The PC parameters may be configured for signaling in a PUSCH, PUCCH, SRS, etc.

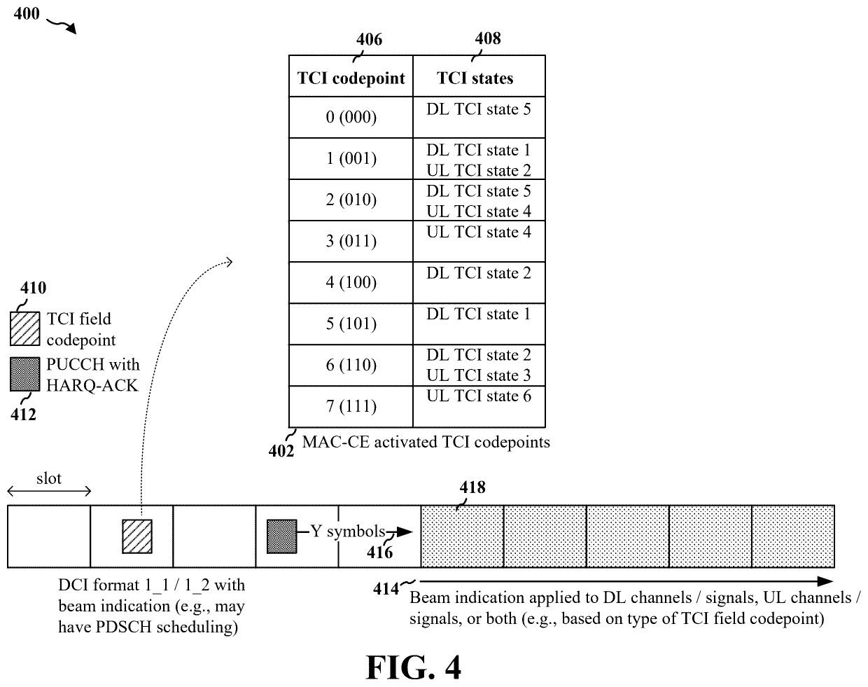

FIG. 4 is a diagram 400 illustrating an example of MAC-CE activation for TCI codepoints. Diagram 400 shows a MAC-CE 402 for activation of TCI codepoints 406 having associated TCI states 408.

As shown, the MAC-CE 402 may include a number of the TCI codepoints 406, e.g., up to eight TCI codepoints, for activation at a UE. The TCI codepoints 406 may be respectively associated with sets of the TCI states 408. The codepoints 406 may be binary number representations, and the TCI states 408 may include one or two TCI states for UL and/or DL communication, for which the UE may be configured by a network node (e.g., via RRC signaling). In cases for separate DL/UL unified TCI, each TCI codepoint may be mapped to: (i) one DL TCI state, (ii) one UL TCI state, or (iii) one DL TCI state and one UL TCI state. For scenarios with a single TRP and a joint DL/UL unified TCI, each TCI codepoint may be mapped to one joint TCI state. When the MAC-CE 402 maps a DL TCI state or an UL TCI state to a single TCI codepoint of the TCI codepoints 406, it may be applied to the DL or the UL messages (or signals/channel), and DCI-based beam indication may be unutilized in such a case. Otherwise, a DCI (e.g., format 1_1/1_2) with a TCI field codepoint 410 may be utilized as a beam indication 414 to indicate one of the TCI codepoints 406. In aspects, the DCI may also include a PDSCH scheduling. As show, a number of symbols 416 (“Y”) after a PUCCH 412 (e.g., with HARQ-ACK information of the PDSCH), the beam indication 414 may be applied, starting at a slot after the number of symbols 416, for DL channels and/or UL channels 418, or both (e.g., based on a type of the TCI field codepoint 410.

However, current TCI state configurations lack support of separate UL power control for PUSCH, PUCCH, SRS, etc., transmissions in SBFD symbols and non-SBFD symbols. That is, while solutions provide for unified TCI state frameworks, as noted above, such frameworks do not enable a network node to configure a UE for duplex-specific power control for such unified TCI frameworks. Accordingly, nor do current solutions enable the configuration of a UE with separate PC parameters for duplex-specific power control.

Aspects provide TCI state enhancement for SBFD. The objective is to set power control (PC) parameters for different uplink messages (or signals/channels) using a unified TCI states framework. The described aspects for duplex-specific power control for a unified TCI framework provide UE configurations that enable solutions to the TCI state issues noted herein, and accordingly, separate, joint, and/or shared sets of configured and/or activated TCI states and associated TCI codepoints, per duplex type, are enabled by aspects herein. Aspects enable separate UL power control in SBFD symbols and in non-SBFD symbols by providing TCI configurations for duplex-specific power control. Aspects enable duplex-specific power control for a unified TCI framework in different operating scenarios by enabling flexibility in such TCI configurations for duplex-specific power control. Aspects also enable the configuration of a UE with separate PC parameters by providing duplex-specific indications in a MAC-CE and/or DCI.

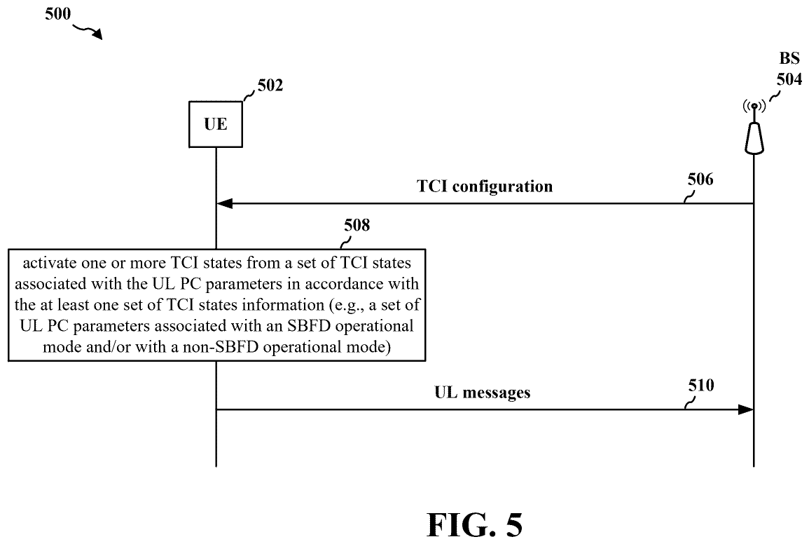

FIG. 5 is a call flow diagram 500 for wireless communications, in various aspects. Call flow diagram 500 illustrates duplex-specific power control for a unified TCI framework for a UE (e.g., a UE 502), by way of example, that communicates with a network node (e.g., a base station 504, a gNB, etc., as shown and described herein), by way of example. While call flow diagram 500 is illustrated and described with respect to a base station, aspects include that the base station 504 may be two or more base stations. Aspects described for base stations, and for network nodes/entities herein, generally, may be performed in aggregated form and/or by one or more components in disaggregated form. Additionally, or alternatively, the aspects may be performed by a UE autonomously, in addition to, and/or in lieu of, operations of a network node/base station.

In the illustrated aspect, the UE 502 may be configured to receive, and the base station 504 may be configured to transmit/provide, a TCI configuration 506. That is, the base station 504 may configure the UE 502 with the TCI configuration 506. The UE 502 may be configured to receive, and the base station 504 may be configured to transmit/provide/configure, the TCI configuration 506 that may be indicative of the at least one set of TCI states information via RRC signaling. In aspects, the TCI configuration 506 may include and/or be indicative of at least one set of TCI states information (e.g., may be multiple sets or a single set of TCI states information), which may include and/or be indicative of a set of UL PC parameters (e.g., PC parameters, generally) associated with an SBFD operational mode and/or with a non-SBFD operational mode. A set of TCI states information, as described herein, may be associated with a BW(s)/BWP(s) of the UE 502.

In some aspects, at least one set of TCI states information may be indicative of at least one of (i) a first set of TCI states information, associated with the SBFD operational mode, that includes an SBFD UL PC parameters or (ii) a second set of TCI states information, associated with the non-SBFD operational mode, that includes a non-SBFD UL PC parameters.

In some aspects, at least one set of TCI states information may be indicative of a joint set of TCI states information that comprises (i) a first joint subset associated with the SBFD operational mode that includes an SBFD UL PC parameter for each TCI in the first subset and (ii) a second joint subset associated with the non-SBFD operational mode that includes a non-SBFD UL PC parameter for each TCI in the second subset. The first joint subset may comprise a first half of the joint set of TCI states information and the second joint subset may comprise a second half of the joint set of TCI states information. Additionally, or alternatively, the TCI configuration may include an RRC parameter indicative of a DL/joint TCI indication or an UL TCI indication associated with the SBFD operational mode and/or the non-SBFD operational mode for the joint set of TCI states information. In some aspects associated with the joint set of TCI states information, the RRC signaling may indicate an increase (e.g., a doubling) of a maximum number of TCI states in the set of TCI states to accommodate the splits of the TCI states identifiers (IDs). In aspects associated with joint sets of TCI states information, the SBFD operational mode and the non-SBFD operational mode have a same unified TCI type.

In some aspects, at least one set of TCI states information may be indicative of a shared set of TCI states information for the SBFD operational mode and the non-SBFD operational mode that comprises (i) a first shared subset associated with UL transmissions and (ii) a second shared subset associated with DL transmissions.

The UE 502 may be configured to activate (at 508) one or more TCI states from a set of TCI states associated with the UL PC parameters in accordance with the at least one set of TCI states information. The activation (at 508) may be performed by the UE 502 in accordance with at least one set of TCI states information (e.g., which may include and/or be indicative of the set of UL PC parameters associated with the SBFD operational mode and/or with the non-SBFD operational mode. In aspects, the UE 502 may be configured to activate (at 508) the one or more TCI states from the set of TCI states associated with the UL PC parameters based on, and/or including, being configured to receive, e.g., from the base station 504 (e.g., a network node), a MAC-CE associated with the TCI configuration 506.

In some aspects, the MAC-CE may include a 1-bit duplex set indication that is indicative of the one or more TCI states from of the set of TCI states activated for the SBFD operational mode or the non-SBFD operational mode. In such aspects, the UE 502 may also be configured to receive, as a part of the TCI configuration 506 and/or of the activation (at 508), DCI indicative of the SBFD operational mode or the non-SBFD operational mode indicative of the one or more TCI states from the set of active TCI states associated with an indicated operational mode and/or of the activating. The DCI may be indicative of the SBFD operational mode or the non-SBFD operational mode in accordance with an SBFD symbol type or a non-SBFD symbol type that comprises the DCI. The DCI may be indicative of the SBFD operational mode or the non-SBFD operational mode in accordance with a duplex type of a symbol or a slot of at least one of (i) PDSCH scheduled by the DCI or (ii) a PUCCH triggered by the DCI that includes HARQ-ACK/NACK information. The DCI may be indicative of the SBFD operational mode or the non-SBFD operational mode in accordance with a duplex indication that is indicative of (i) a 1-bit indication of the non-SBFD operational mode or the SBFD operational mode or (ii) multiple 1-bit indications (e.g., two 1-bit indications) of at least one of the non-SBFD operational mode or the SBFD operational mode.

In some aspects, the MAC-CE may be indicative of, and/or include, first subset of the set of TCI codepoints and a second subset of the set of TCI codepoints for at least one of the SBFD operational mode or the non-SBFD operational mode. In aspects, the first subset of the set of TCI codepoints may include a number of TCI codepoints (e.g., at most eight TCI codepoints) associated with the UL PC parameters and the second subset of the set of TCI codepoints may include a number of TCI codepoints (e.g., at most eight TCI codepoints) associated with the UL PC parameters. In aspects, at least one TCI code point of the set of TCI codepoints may be associated with at least one of the SBFD operational mode, the non-SBFD operational mode, or both of the SBFD operational mode and the non-SBFD operational mode.

In some aspects, the MAC-CE may be indicative of, and/or include, an indication, for each codepoint of the set of TCI codepoints, of one or more of (i) at least one associated TCI state of the set of TCI states or (ii) at least one of the SBFD operational mode or the non-SBFD operational mode associated with each codepoint.

In some aspects, the MAC-CE may be indicative of, and/or include, an indication, for each codepoint of the set of TCI codepoints, of at least one associated TCI state of the set of TCI states. In such aspects, the UE 502 may also be configured to receive, as a part of the TCI configuration 506 and/or of the activation (at 508), DCI indicative of at least one of the SBFD operational mode or the non-SBFD operational mode for each associated TCI state of each codepoint of the set of TCI codepoints. In aspects, each codepoint of the set of TCI codepoints may include at most two associated TCI states, and the DCI may include a 1-bit indication of the at least one of the SBFD operational mode or the non-SBFD operational mode for each TCI state of the at most two associated TCI states. In aspects, each codepoint of the set of TCI codepoints may include at most four associated TCI states, and the DCI may include a bitmap indication of the at least one of the SBFD operational mode or the non-SBFD operational mode for each TCI state of the at most four associated TCI states.

As described herein, any receptions and/or activations associated with the TCI configuration 506 and/or the set of TCI states and the set of TCI codepoints associated with the UL PC parameters (activation at 508) may occur prior to, subsequent to, and/or at least partially concurrently with any other receptions and/or activations at/by the UE 502. For instance, in some aspects, an activation (at 508) may also comprise, at least in part, a reception associated with the TCI configuration 506; likewise, in some aspects, an activation (at 508) may also comprise, at least in part, a reception associated with the TCI configuration 506.

The UE 502 may be configured to transmit/provide, and the base station 504 may be configured to receive, e.g., via a set of beams, UL messages 510 (e.g., UL signals/signaling) in accordance a UL PC parameter of a TCI state. The UL PC parameter of the TCI state for transmission of the UL messages 510 may be based on the set of TCI states and the set of TCI codepoints configured via the TCI configuration 506. In aspects, the UE 502 may be configured to receive, and the base station 504 may be configured to transmit/provide, e.g., via a set of beams, DL signals described herein, in accordance a UL PC parameter of a TCI state that may also be based on the set of TCI states and the set of TCI codepoints configured via the TCI configuration 506. That is, the UE 502 and the base station 504 (e.g., a network node, generally) may be configured to communicate via signaling using beams based on a UL PC parameter of a TCI state associated with the set of TCI states and the set of TCI codepoints configured via the TCI configuration 506.

Aspects herein provide that such transmissions (e.g., the UL messages 510), receptions, and/or communications may be based on duplex-specific UL PC parameters (e.g., different UL PC parameters for signaling in an SBFD operational mode than signaling in a non-SBFD operational mode). In other words, TCI states may be configured with a single UL PC parameter, in various embodiments.

Accordingly, separate, joint, and/or shared sets of configured and/or activated TCI states and associated TCI codepoints, per duplex type (e.g., for SBFD and also for non-SBFD), are enabled by aspects herein.

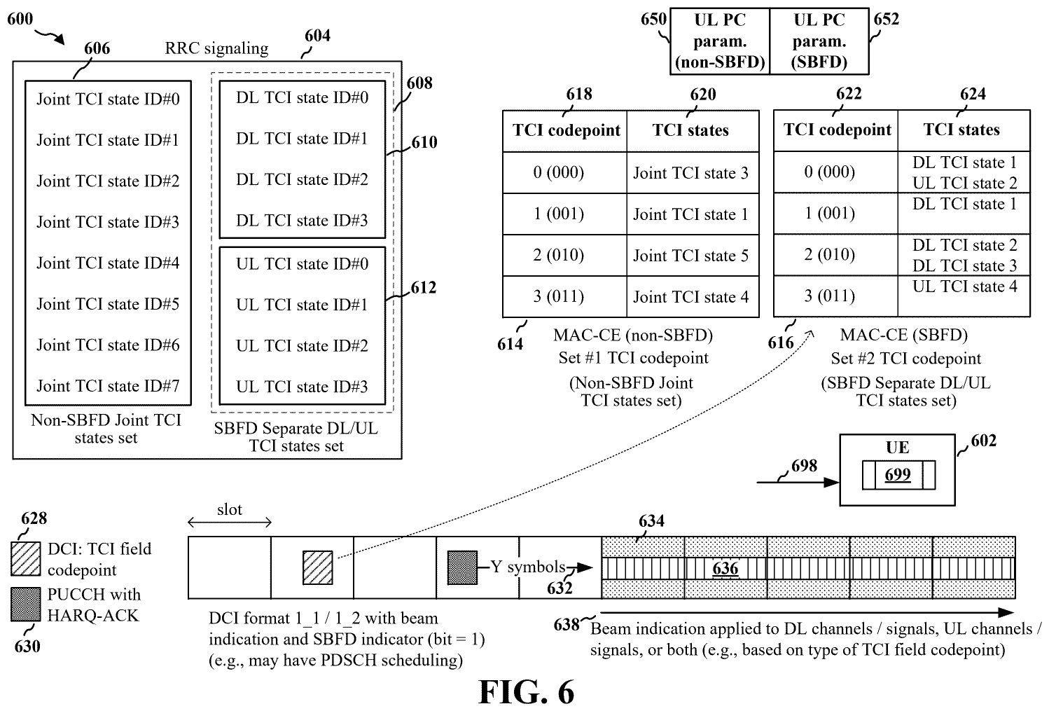

FIG. 6 is a diagram 600 illustrating an example of configuration and activation for TCI codepoints associated with PC parameters for separate sets of duplex-specific TCI states, in various aspects. Diagram 600 shows duplex-specific power control for a unified TCI framework in association with a UE 602, and may be an aspect of the call flow diagram 500 in FIG. 5, as described above. As shown, the UE 602 may be configured to receive, and a network node may be configured to transmit/provide/configure, a TCI configuration 698 (e.g., having a set(s) of TCI states information 604 (also two pools, two lists, and/or the like), e.g., via RRC signaling) and subsequently be activated (at 699) a set of TCI states (e.g., a set of TCI states 620, a set of TCI states 624) and a set of TCI codepoints (e.g., a set of TCI codepoints 618, a set of TCI codepoints 622) associated with the UL PC parameters, in accordance with the set(s) of TCI states information 604, for non-SBFD (e.g., a UL PC parameter 650) and for SBFD (e.g., a UL PC parameter 652) for each TCI state. The set(s) of TCI states information 604 may include a first set of TCI states information 606 associated with non-SBFD joint TCI states and a second set of TCI states information 608 associated with separate SBFD TCI states for DL and UL TCI states, which may include a first subset of TCI states information 610 for DL and a second subset of TCI states information 612 for UL.

The UE 602 may be configured to receive, and a network node may be configured to transmit/provide/configure, a MAC-CE 614 associated with non-SBFD and/or a MAC-CE 616 associated with SBFD, e.g., as part of the TCI configuration 698 and/or as part of activation (at 699) for the set of TCI states (e.g., the set of TCI states 620, the set of TCI states 624) and the set of TCI codepoints (e.g., the set of TCI codepoints 618, the set of TCI codepoints 622) associated with the UL PC parameter 650 and the UL PC parameter 652. Aspects may provide, via the MAC-CE 614 and/or the MAC-CE 616, for two sets of TCI states (e.g., the set of TCI states 620, the set of TCI states 624), with one set of TCI states for each duplex mode (e.g., the set of TCI states 624 for an SBFD operational mode and the set of TCI states 620 for a non-SBFD operational mode, which may be configured per BW or BW part (BWP) of the UE 602). Each TCI state of the set of TCI states for the SBFD operational mode (e.g., the set of TCI states 624) (or conversely for the non-SBFD operational mode (e.g., the set of TCI states 620)) may be configured with a proper/respective UL PC parameter for the SBFD operational mode (or conversely the non-SBFD operational mode), e.g., for non-SBFD: the UL PC parameter 650; and for SBFD: the UL PC parameter 652. The set of TCI codepoints 618 (Set #1 TCI codepoint, for non-SBFD joint TCI states) associated with the set of TCI states 620 may be included with/indicated by the MAC-CE 614, and the set of TCI codepoints 622 (Set #2 TCI codepoint, for separate SBFD TCI states for DL and UL TCI states) associated with the set of TCI states 624 may be included with/indicated by the MAC-CE 616.

The MAC-CE 614 and/or the MAC-CE 616 may include/indicate a 1-bit duplex-type indicator associated with the first set of TCI states information 606 associated with non-SBFD joint TCI states and the second set of TCI states information 608 associated with separate SBFD TCI states for DL and UL TCI states to activate one or multiple TCI codepoint(s)/states within the corresponding set of TCI states (e.g., the set of TCI codepoints 618/the set of TCI states 620 for non-SBFD; the set of TCI codepoints 622/the set of TCI states 624 for SBFD). That is, the UE 602 may be configured to receive two MAC-CEs (e.g., the MAC-CE 614 and/or the MAC-CE 616) to activate two sets of TCI codepoints/states for non-SBFD and SBFD.

Aspects also provide for configuration/indication of the UE 602 based on DCI 628, which may include/indicate a TCI field codepoint. For instance, the UE 602 may be configured to receive, and a network node may be configured to transmit/provide/configure, the DCI 628 associated with SBFD, e.g., as part of the TCI configuration 698 and/or as part of activation (at 699) for the set of TCI states (e.g., the set of TCI states 620, the set of TCI states 624) and the set of TCI codepoints (e.g., the set of TCI codepoints 618, the set of TCI codepoints 622) associated with the UL PC parameter 650 and the UL PC parameter 652. Whether the DCI 628 indication of TCI codepoint/states is applicable to the set of TCI codepoints 618 (non-SBFD) or the set of TCI codepoints 622 (SBFD) may be based on various information. In one aspect, the applicable TCI codepoint/states may be implicitly based on a symbol type where the DCI 628 is received. As one example, DCI received in a non-SBFD symbol may indicate set of TCI codepoints 618 (non-SBFD), while DCI received in an SBFD symbol may indicate the set of TCI codepoints 622 (SBFD). In another aspect, the applicable TCI codepoint/states may be based on a slot/symbol type of a scheduled PDSCH indicted by the DCI 628 (e.g., based on a K0 offset) and/or slot of a PUCCH 630 carrying HARQ ACK/NACK information (e.g., based on a K1 offset). As one example, the DCI 628 may be a DCI format 1_1/1_2 with a beam indication 638 and an SBFD indicator (e.g., bit=1) or a non-SBFD indicator (e.g., bit=0), and may include PDSCH scheduling, according to aspects. In another aspect, the applicable TCI codepoint/states may be based on an explicit indicator by a single DCI duplex indicator of the DCI 628 (e.g., 0: non-SBFD, ‘1’: SBFD), and/or the DCI 628 may include/indicate multiple bitfields (e.g., two or more 1-bit indications) of the TCI codepoint/states indicator for at least one of the non-SBFD operational mode or the SBFD operational mode. In some aspects, the DCI may include two fields for TCI codepoint indicators, e.g., one for selecting one TCI codepoint out of the set of SBFD TCI codepoints (618) and another one for selecting one TCI codepoint out of the set of non-SBFD TCI codepoints (622).

The beam indication 638 may be applied at a slot after a number of symbols 632 (“Y”) after the PUCCH 630 for DL channels/signals 634, for UL channels/signals 636, or for both (e.g., depending on the type of TCI field codepoint) for the SBFD operational mode.

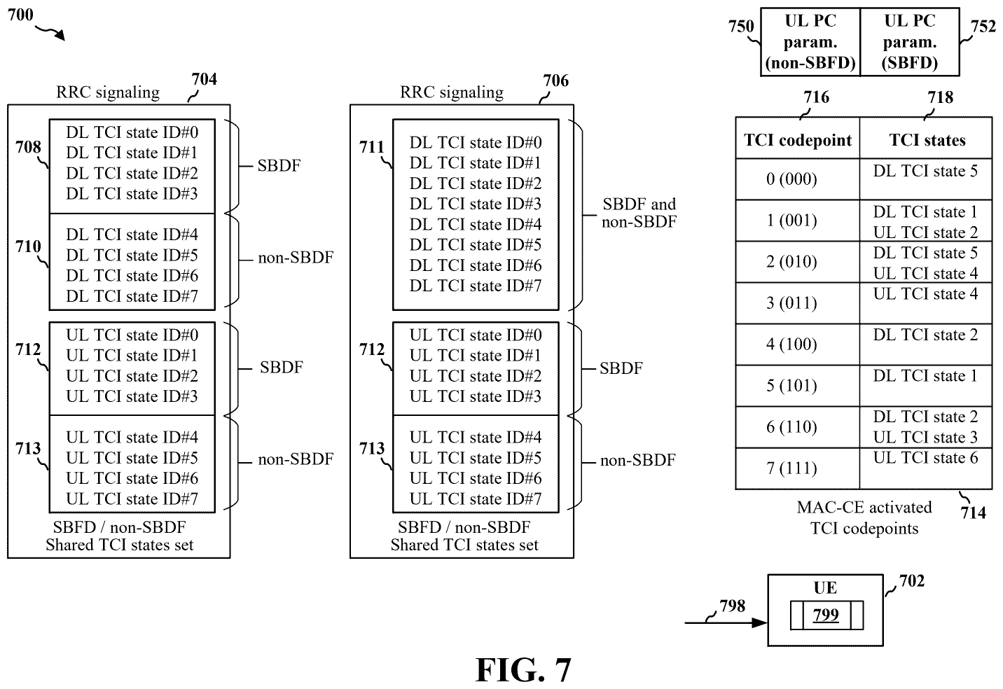

FIG. 7 is a diagram 700 illustrating an example of configuration and activation for TCI codepoints associated with UL PC parameters for a joint set of duplex-specific TCI states, in various aspects. Diagram 700 shows duplex-specific power control for a unified TCI framework in association with a UE 702, and may be an aspect of the call flow diagram 500 in FIG. 5, as described above. As shown, the UE 602 may be configured to receive, and a network node may be configured to transmit/provide/configure, a TCI configuration 798 (e.g., having a joint set(s) of TCI states information 704 and/or a joint set(s) of TCI states information 706 (also two pools, two lists, and/or the like), e.g., via RRC signaling) and subsequently be activated (at 799) with a set of TCI codepoints (e.g., a set of TCI codepoints 716) that include the set of TCI states (e.g., a set of TCI states 718) and associated with the UL PC parameters, in accordance with the joint set(s) of TCI states information 704 and/or the joint set(s) of TCI states information 706, for non-SBFD (e.g., a UL PC parameter 750) and for SBFD (e.g., a UL PC parameter 752). The joint set(s) of TCI states information 704 may include a first set of TCI states information 708 (DL) and a third set of TCI states information 712 (UL) associated with SBFD TCI states (e.g., separate DL and UL TCI states for SBFD operation), and a second set of TCI states information 710 (DL) and a fourth set of TCI states information 713 (UL) associated with non-SBFD TCI states (e.g., separate DL and UL TCI state for non-SBFD operation). The joint set(s) of TCI states information 706 may include a fifth set of TCI states information 711 (DL) associated with non-SBFD and SBFD DL TCI states, and the third set of TCI states information 712 (UL) associated with SBFD UL TCI states and the fourth set of TCI states information 713 (UL) associated with non-SBFD UL TCI states.

The UE 702 may be configured to receive, and a network node may be configured to transmit/provide/configure, a MAC-CE 714 associated with non-SBFD and/or with SBFD, e.g., as part of the TCI configuration 798 and/or as part of activation (at 799) for the set of TCI states (e.g., the set of TCI states 718) and the set of TCI codepoints (e.g., the set of TCI codepoints 716) associated with the UL PC parameter 750 and the UL PC parameter 752. Aspects may provide, via the MAC-CE 714, the set of TCI states 718 associated with both duplex types (e.g., non-SBFD and SBFD), which may be configured per BW or BWP of the UE 702. Each TCI state of the set of TCI states (e.g., the set of TCI states 718) for the SBFD operational mode/the non-SBFD operational mode may be configured with a proper/respective UL PC parameter, e.g., for non-SBFD: the UL PC parameter 750; and for SBFD: the UL PC parameter 752. The set of TCI codepoints 716 associated with the set of TCI states 718 may be included with/indicated by the MAC-CE 714.

Aspects herein provide for a split of the set of TCI states 718 across SBFD and non-SBFD operational modes. As one example, a first half of the TCI state IDs (e.g., 1-64) may be allocated/designate for non-SBFD, and a second half of TCI state IDs (e.g., 65-127) may be allocated/designate for SBFD, or vice versa. In another example, an RRC parameter of RRC signaling for the TCI configuration 798, e.g., within the DL/Joint TCI or UL-TCI sub-configurations, may indicate the applicable duplex type (SBFD or non-SBFD). In aspects, to accommodate the splits of TCI state IDs, the maximum number of configured TCI states may be increased (e.g., doubled), and such an indication may be provided to the UE 702 via RRC signaling, such as with the TCI configuration 798 or otherwise. In aspects, such as those described above and shown for FIG. 7, the SBFD operational mode and the non-SBFD operational mode may have a same unified TCI type.

The MAC-CE 714 may be configured to activate (at 799) up to eight (8) TCI codepoints, as the set of TCI codepoints 716, from the shared pool of TCI states information (e.g., the joint set(s) of TCI states information 704 and/or a joint set(s) of TCI states information 706) and corresponding to the set of TCI states 718. In some aspects, a TCI codepoint of the set of TCI codepoints 716 may have mixed TCI states of different duplex types (e.g., SBFD and non-SBFD), while in other aspects a TCI codepoint of the set of TCI codepoints 716 may not have mixed TCI states of different duplex types (e.g., SBFD or non-SBFD). For example, when separate UL/DL TCI states are used for a given TCI codepoint, both TCI states may not be on same duplex type (e.g., both on SBFD or both on non-SBFD); as another example for a given TCI codepoint, both TCI states may be on same duplex type (e.g., both on SBFD and non-SBFD), and thus, the indicated TCI codepoint may update an UL-beam in one duplex symbol type and a DL-beam in another duplex type.

As shown, in one example for the set of TCI states information 704, if a TCI field codepoint of the MAC-CE 714 indicates a code point of the set of TCI codepoints 716 as “(000),” after application time, the UE 702 may be configured to switch beams in the non-SBFD operational mode symbols to UL beam 2 and DL beam 1. In another case for the example, if a TCI field codepoint of the MAC-CE 714 indicates a code point of the set of TCI codepoints 716 as “(100),” after application time, the UE 702 may be configured to switch beams in the SBFD operational mode symbols to UL beam 5 and DL beam 4.

Referring to an example for the set of TCI states information 706, because UL-UL PC parameters may be defined per UL-TCI states when separate UL/DL is used, the DL TCI pool may be applicable for SBFD and only UL TCI states may be different for SBFD and non-SBFD symbols. In such aspects, an RRC parameter per PDCCH-configuration may indicate whether DL/Joint TCI is applicable to both symbol types or not. For instance, regarding the set of TCI states information 706, if a TCI field codepoint of the MAC-CE 714 indicates a code point of the set of TCI codepoints 716 as “(000),” after application time, the UE 702 may be configured to switch UL beams in the non-SBFD operational mode symbols to UL beam 2 and to DL beam 1 for both non-SBFD and SBFD symbols. In another case for the example, if a TCI field codepoint of the MAC-CE 714 indicates a code point of the set of TCI codepoints 716 as “(100),” after application time, the UE 702 may be configured to switch beams in the SBFD operational mode symbols to UL beam 5 and to DL beam 4 for both non-SBFD and SBFD symbols.

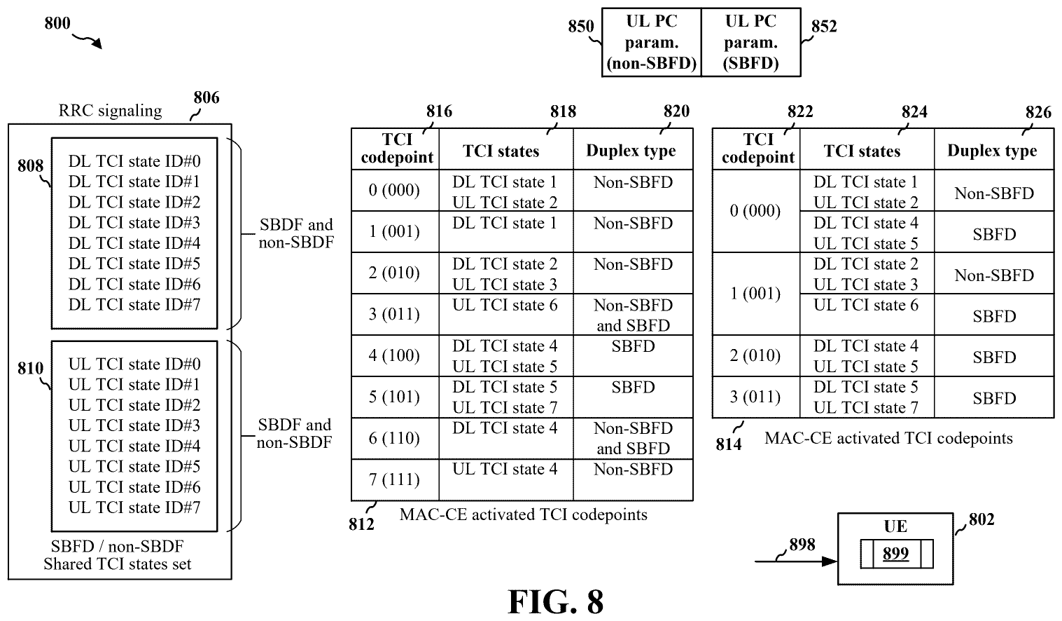

FIG. 8 is a diagram 800 illustrating an example of configuration and activation for TCI codepoints associated with UL PC parameters for a shared set of duplex-specific TCI states, in various aspects. Diagram 800 shows duplex-specific power control for a unified TCI framework in association with a UE 802, and may be an aspect of the call flow diagram 500 in FIG. 5, as described above. As shown, the UE 802 may be configured to receive, and a network node may be configured to transmit/provide/configure, a TCI configuration 898 (e.g., having a set(s) of TCI states information 806 (also a pool, a list, and/or the like), e.g., via RRC signaling) and subsequently be configured to activate (at 899) a set of TCI states (e.g., a set of TCI states 818, a set of TCI states 824) and a set of TCI codepoints (e.g., a set of TCI codepoints 816, a set of TCI codepoints 822) associated with the UL PC parameters, in accordance with the set(s) of TCI states information 806, for non-SBFD (e.g., a UL PC parameter 850) and for SBFD (e.g., a UL PC parameter 852). In aspects for diagram 800, a TCI state may be applicable to both SBFD and non-SBFD with a same UL PC parameter for both (e.g., the UL PC parameter 850 is the same as the UL PC parameter 852), although the duplex type may not be indicated by TCI states information 806. The set(s) of TCI states information 806 may include a first shared set of TCI states information 808 associated with non-SBFD/SBFD shared TCI states for DL TCI states and a second shared set of TCI states information 810 associated with non-SBFD/SBFD shared TCI states for UL TCI states. That is, aspects provide for a shared set/list/pool of TCI states for both duplex modes.

In aspects, there may be no duplex-type indicator on the configured TCI state IDs, as noted above, although non-SBFD and/or SBFD may be utilized. However, a MAC-CE may include/indicate via a TCI-codepoint the duplex type for the activated TCI codepoints or states, either SBFD, non-SBFD or both. For example, the UE 802 may be configured to receive, and a network node may be configured to transmit/provide/configure, a MAC-CE 812 and/or a MAC-CE 814 associated with non-SBFD and SBFD shared TCI states, e.g., as part of the TCI configuration 898 and/or as part of activation (at 899) for the set of TCI states (e.g., the set of TCI states 818, the set of TCI states 824) and the set of TCI codepoints (e.g., the set of TCI codepoints 816, the set of TCI codepoints 822) associated with the UL PC parameter 850 and the UL PC parameter 852. That is, the configured TCI states may be applicable to both SBFD and non-SBFD, and the same UL PC parameter for both. In aspects, the MAC-CE 812 may include a TCI codepoint with up to two TCI states. In aspects, the MAC-CE 814 may include a TCI codepoint with up to four TCI states.

As one example, the MAC-CE 812 may include a duplex type indication 820, such as non-SBFD (e.g., bit=0) or SBFD (e.g., bit=1), or vice versa, associated with each of the set of TCI states 818 and the set of TCI codepoints 816. As another example, the MAC-CE 814 may include a duplex type indication 826, such as non-SBFD (e.g., bit=0) or SBFD (e.g., bit=1), or vice versa, associated with each of the set of TCI states 824 and the set of TCI codepoints 822. The duplex type indication 820 for MAC-CE may indicate the duplex type for each TCI codepoint of the set of TCI codepoints 816 (e.g., all TCI states for each TCI codepoint have the same duplex type as ‘SBFD’ or ‘non-SBFD’ or ‘both SBFD and non-SBFD’) or the duplex type indication 826 may indicate different duplex types for the TCI states within one TCI codepoint of the TCI codepoints 822.

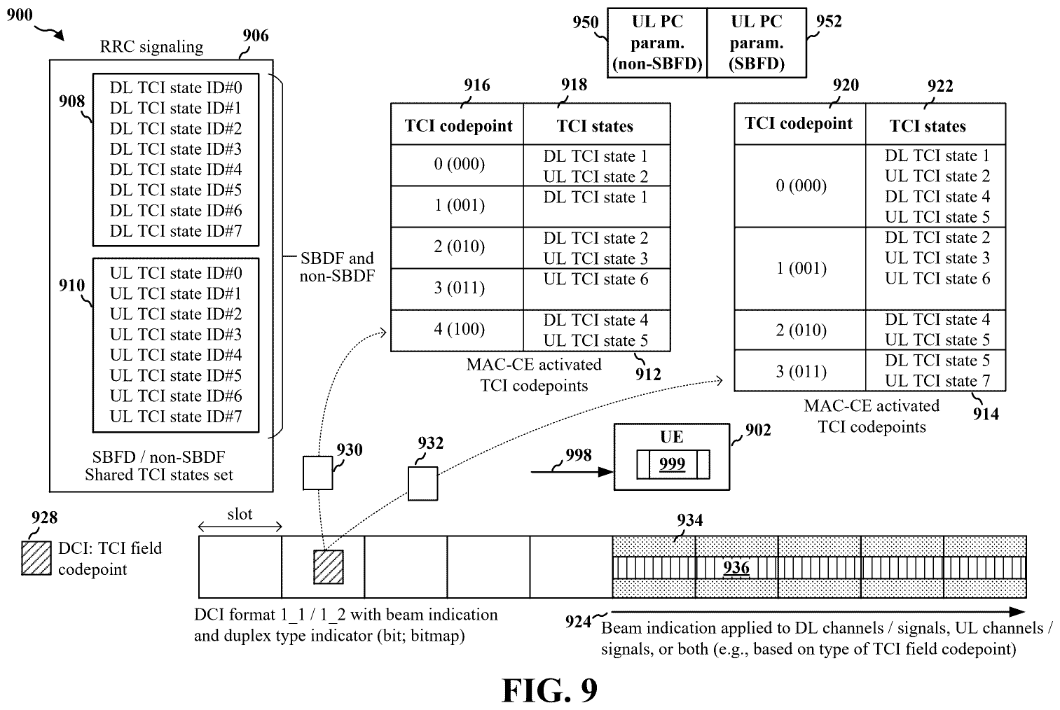

FIG. 9 is a diagram 900 illustrating an example of configuration and activation for TCI codepoints associated with PC parameters for a shared set of duplex-specific TCI states, in various aspects. Diagram 900 shows duplex-specific power control for a unified TCI framework in association with a UE 902, and may be an aspect of the call flow diagram 500 in FIG. 5, as described above. As shown, the UE 902 may be configured to receive, and a network node may be configured to transmit/provide/configure, a TCI configuration 998 (e.g., having a set(s) of TCI states information 906 (also a pool, a list, and/or the like), e.g., via RRC signaling) and subsequently be configured to activate (at 999) a set of TCI states (e.g., a set of TCI states 918, a set of TCI states 922) and a set of TCI codepoints (e.g., a set of TCI codepoints 916, a set of TCI codepoints 920) associated with the UL PC parameters, in accordance with the set(s) of TCI states information 906, for non-SBFD (e.g., a UL PC parameter 950) and for SBFD (e.g., a UL PC parameter 952). In aspects for diagram 900, a TCI state may be applicable to both SBFD and non-SBFD with a same UL PC parameter for both (e.g., the UL PC parameter 950 is the same as the UL PC parameter 952), although the duplex type may not be indicated by the set(s) of TCI states information 906. The set(s) of TCI states information 906 may include a first shared set of TCI states information 908 associated with non-SBFD/SBFD shared TCI states for DL TCI states and a second shared set of TCI states information 910 associated with non-SBFD/SBFD shared TCI states for UL TCI states. That is, aspects provide for a shared set/list/pool of TCI states for both duplex modes.

In aspects, there may be no duplex-type indicator on the configured TCI state IDs, as noted above, although non-SBFD and/or SBFD may be utilized. Additionally, a MAC-CE may not include/indicate the duplex type of the activated TCI state(s). In such aspects, DCI 928 may include/indicate the duplex type for the activated TCI codepoints or states, either SBFD, non-SBFD or both. Regarding the utilization of MAC-CE, the UE 902 may be configured to receive, and a network node may be configured to transmit/provide/configure, a MAC-CE 912 and/or a MAC-CE 914 associated with non-SBFD and SBFD shared TCI states, e.g., as part of the TCI configuration 998 and/or as part of activation (at 999) for the set of TCI states (e.g., the set of TCI states 918, the set of TCI states 922) and the set of TCI codepoints (e.g., the set of TCI codepoints 916, the set of TCI codepoints 920) associated with the UL PC parameter 950 and the UL PC parameter 952. In aspects, the MAC-CE 912 may include up to two TCI states. In aspects, the MAC-CE 914 may include up to four TCI states.

In aspects for FIG. 9, the configured set of TCI states may be applicable to both SBFD and non-SBFD, the indication of the duplex type of the activated TCI state(s) is not provided via the MAC-CE and the DCI 928 may indicate the applicable duplex type of the indicated TCI states/codepoints. For instance, the UE 902 may be configured to receive, and a network node may be configured to transmit/provide/configure, the DCI 928, e.g., as part of the TCI configuration 998 and/or as part of activation (at 999) for the set of TCI states (e.g., the set of TCI states 918, the set of TCI states 922) and the set of TCI codepoints (e.g., the set of TCI codepoints 916, the set of TCI codepoints 920) associated with the UL PC parameter 950 and the UL PC parameter 952. In some aspects, for cases when the TCI codepoint has up to two TCI states (e.g., for the MAC-CE 912 and the set of TCI codepoints 916, the set of TCI states 918), a 1-bit field indicator in the DCI 928 may indicate the applicable duplex types, such as non-SBFD (e.g., bit=0) or SBFD (e.g., bit=1), or vice versa. In aspects, for cases when the TCI codepoint has up to four TCI states per TCI codepoint, (e.g., for the MAC-CE 914 and the set of TCI codepoints 920, the set of TCI states 922), a bitmap in the DCI 928 may indicate the applicable duplex type for each TCI state in the TCI codepoint, such as non-SBFD (e.g., a bitmap bit=0 at a position corresponding to the TCI codepoint/state) or SBFD (e.g., a bitmap bit=1 at a position corresponding to the TCI codepoint/state). As an illustrative example generally, for a four-bit bitmap, the second bit may correspond to a second TCI state of a TCI codepoint, the third bit may correspond to a third TCI state of a TCI codepoint, the first bit may correspond to a first TCI state of a TCI codepoint, and the fourth bit may correspond to a fourth TCI state of a TCI codepoint.

The DCI 928 may be a DCI format 1_1/1_2 with a beam indication 924 and a duplex type indicator (e.g., a bit indicator 930 or a bitmap 932) for SBFD/non-SBFD operational mode indications of the indicated TCI states. The beam indication 924 may be applied after a number of slots subsequent to the DCI 928 for DL channels/signals 934, for UL channels/signals 936, or for both (e.g., depending on the type of TCI field codepoint and information therein).

As an example for the set of TCI states information 906 and the MAC-CE 912, if a TCI field codepoint of the DCI 928 indicates a code point of the set of TCI codepoints 916 as “(000)” and a duplex type indicator (e.g., 1 bit) of non-SBFD, after application time, the UE 902 may be configured to switch UL beams in the non-SBFD operational mode (e.g., SBFD symbols) to UL TCI #2 (e.g., UL beam 2 and a corresponding UL PC parameter) and to DL TCI #1 (DL beam 1 and corresponding QCL information). In another case for the example, if a TCI field codepoint of the DCI 928 indicates a code point of the set of TCI codepoints 916 as “(100)” and a duplex type indicator (e.g., 1 bit) of SBFD, after application time, the UE 902 may be configured to switch beams in the SBFD operational mode symbols to UL beam 5 and to DL beam 4.

As an example for the set of TCI states information 906 and the MAC-CE 914, if a TCI field codepoint of the DCI 928 indicates a code point of the set of TCI codepoints 916 as “(000)” and a duplex type indicator (e.g., a bitmap) as DL/UL TCI states 1/2 for non-SBFD and DL/UL TCI states 4/5 for SBFD, after application time, the UE 902 may be configured to switch DL/UL beams in the non-SBFD operational mode symbols to beam 1/2 and to switch DL/UL beams in the SBFD operational mode symbols to beam 4/5. In another case for the example, if a TCI field codepoint of the DCI 928 indicates a code point of the set of TCI codepoints 916 as “(011)” and a duplex type indicator (e.g., a bitmap) as DL/UL TCI states 4/7 for SBFD, after application time, the UE 902 may be configured to switch DL/UL beams in the SBFD operational mode symbols to beam 4/5.

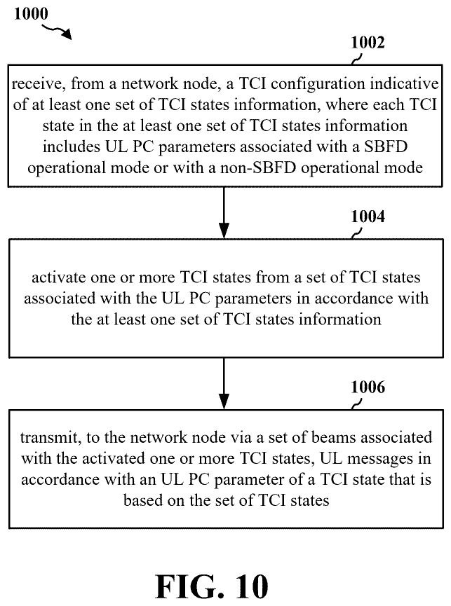

FIG. 10 is a flowchart 1000 of a method of wireless communication. The method may be performed by a UE (e.g., the UE 104, 502, 602, 702, 802, 902; the apparatus 1104). The method may be for duplex-specific power control for a unified TCI framework. The method may provide for enabling separate UL power control in SBFD symbols and in non-SBFD symbols by providing TCI configurations for duplex-specific power control, enabling duplex-specific power control for a unified TCI framework in different operating scenarios by enabling flexibility in such TCI configurations for duplex-specific power control, and enabling the configuration of a UE with separate UL PC parameters by providing duplex-specific indications in a MAC-CE and/or DCI.

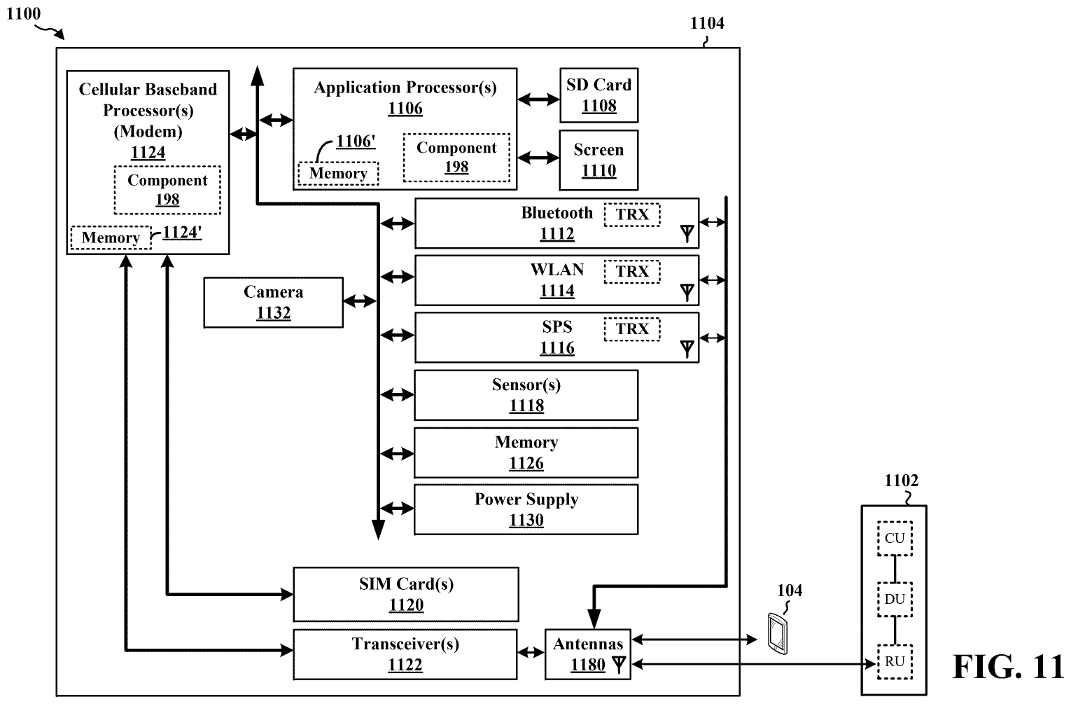

At 1002, the UE receives, from a network node, a TCI configuration indicative of at least one set of TCI states information, where each TCI state in the at least one set of TCI states information includes UL PC parameters associated with a SBFD operational mode or with a non-SBFD operational mode. As an example, the reception may be performed by one or more of the component 198, the transceiver(s) 1122, and/or the antenna 1180 in FIG. 11. FIG. 5 illustrates, in the context of FIGS. 6, 7, 8, 9, an example of the UE 502 receiving such a TCI configuration from a network node (e.g., the base station 504).

The UE 502 may be configured to receive, and the base station 504 may be configured to transmit/provide, a TCI configuration 506 (e.g., 698 in FIG. 6; 798 in FIG. 7; 898 in FIG. 8; 998 in FIG. 9). That is, the base station 504 may configure the UE 502 with the TCI configuration 506 (e.g., 698 in FIG. 6; 798 in FIG. 7; 898 in FIG. 8; 998 in FIG. 9). The UE 502 may be configured to receive, and the base station 504 may be configured to transmit/provide/configure, the TCI configuration 506 (e.g., 698 in FIG. 6; 798 in FIG. 7; 898 in FIG. 8; 998 in FIG. 9) that may be indicative of the at least one set of TCI states information (e.g., 606, 608, 610, 612 in FIG. 6; 708, 710, 711, 712, 713 in FIG. 7; 808, 810 in FIG. 8; 908, 910 in FIG. 9) via RRC signaling (e.g., 604 in FIG. 6; 704, 706 in FIG. 7; 806 in FIG. 8; 906 in FIG. 9). In aspects, the TCI configuration 506 (e.g., 698 in FIG. 6; 798 in FIG. 7; 898 in FIG. 8; 998 in FIG. 9) may include and/or be indicative of at least one set of TCI states information (e.g., may be multiple sets or a single set of TCI states information) (e.g., 606, 608, 610, 612 in FIG. 6; 708, 710, 711, 712, 713 in FIG. 7; 808, 810 in FIG. 8; 908, 910 in FIG. 9), which may include and/or be indicative of a set of UL PC parameters (e.g., 650, 652 in FIG. 6; 750, 752 in FIG. 7; 850, 852 in FIG. 8; 950, 952 in FIG. 9) associated with an SBFD operational mode and with a non-SBFD operational mode. A set of TCI states information (e.g., 606, 608, 610, 612 in FIG. 6; 708, 710, 711, 712, 713 in FIG. 7; 808, 810 in FIG. 8; 908, 910 in FIG. 9), as described herein, may be associated with a BW(s)/BWP(s) of the UE 502.

In some aspects, at least one set of TCI states information (e.g., 606, 608, 610, 612 in FIG. 6; 708, 710, 711, 712, 713 in FIG. 7; 808, 810 in FIG. 8; 908, 910 in FIG. 9) may be indicative of at least one of (i) a first set of TCI states information (e.g., 606, 608, 610, 612 in FIG. 6; 708, 710, 711, 712, 713 in FIG. 7; 808, 810 in FIG. 8; 908, 910 in FIG. 9), associated with the SBFD operational mode, that includes an SBFD UL PC parameters (e.g., 650, 652 in FIG. 6; 750, 752 in FIG. 7; 850, 852 in FIG. 8; 950, 952 in FIG. 9) or (ii) a second set of TCI states information (e.g., 606, 608, 610, 612 in FIG. 6; 708, 710, 711, 712, 713 in FIG. 7; 808, 810 in FIG. 8; 908, 910 in FIG. 9), associated with the non-SBFD operational mode, that includes a non-SBFD UL PC parameters (e.g., 650, 652 in FIG. 6; 750, 752 in FIG. 7; 850, 852 in FIG. 8; 950, 952 in FIG. 9).

In some aspects, at least one set of TCI states information (e.g., 606, 608, 610, 612 in FIG. 6; 708, 710, 711, 712, 713 in FIG. 7; 808, 810 in FIG. 8; 908, 910 in FIG. 9) may be indicative of a joint set of TCI states information (e.g., 606, 608, 610, 612 in FIG. 6; 708, 710, 711, 712, 713 in FIG. 7; 808, 810 in FIG. 8; 908, 910 in FIG. 9) that comprises (i) a first joint subset associated with the SBFD operational mode that includes an SBFD UL PC parameter (e.g., 650, 652 in FIG. 6; 750, 752 in FIG. 7; 850, 852 in FIG. 8; 950, 952 in FIG. 9) for each TCI in the first subset and (ii) a second joint subset associated with the non-SBFD operational mode that includes a non-SBFD UL PC parameter (e.g., 650, 652 in FIG. 6; 750, 752 in FIG. 7; 850, 852 in FIG. 8; 950, 952 in FIG. 9) for each TCI in the second subset. The first joint subset may comprise a first half of the joint set of TCI states information (e.g., 606, 608, 610, 612 in FIG. 6; 708, 710, 711, 712, 713 in FIG. 7; 808, 810 in FIG. 8; 908, 910 in FIG. 9) and the second joint subset may comprise a second half of the joint set of TCI states information (e.g., 606, 608, 610, 612 in FIG. 6; 708, 710, 711, 712, 713 in FIG. 7; 808, 810 in FIG. 8; 908, 910 in FIG. 9). Additionally, or alternatively, the TCI configuration may include an RRC parameter indicative of a DL/joint TCI indication or an UL TCI indication associated with the SBFD operational mode and/or the non-SBFD operational mode for the joint set of TCI states information (e.g., 606, 608, 610, 612 in FIG. 6; 708, 710, 711, 712, 713 in FIG. 7; 808, 810 in FIG. 8; 908, 910 in FIG. 9). In some aspects associated with the joint set of TCI states information (e.g., 606, 608, 610, 612 in FIG. 6; 708, 710, 711, 712, 713 in FIG. 7; 808, 810 in FIG. 8; 908, 910 in FIG. 9), the RRC signaling (e.g., 604 in FIG. 6; 704, 706 in FIG. 7; 806 in FIG. 8; 906 in FIG. 9) may indicate an increase (e.g., a doubling) of a maximum number of TCI states in the set of TCI states (e.g., 620, 624 in FIG. 6; 718 in FIG. 7; 818, 824 in FIG. 8; 918, 922 in FIG. 9) to accommodate the splits of the TCI state identifiers (IDs). In aspects associated with joint sets of TCI states information (e.g., 606, 608, 610, 612 in FIG. 6; 708, 710, 711, 712, 713 in FIG. 7; 808, 810 in FIG. 8; 908, 910 in FIG. 9), the SBFD operational mode and the non-SBFD operational mode have a same unified TCI type.

In some aspects, at least one set of TCI states information (e.g., 606, 608, 610, 612 in FIG. 6; 708, 710, 711, 712, 713 in FIG. 7; 808, 810 in FIG. 8; 908, 910 in FIG. 9) may be indicative of a shared set of TCI states information (e.g., 606, 608, 610, 612 in FIG. 6; 708, 710, 711, 712, 713 in FIG. 7; 808, 810 in FIG. 8; 908, 910 in FIG. 9) for the SBFD operational mode and the non-SBFD operational mode that comprises (i) a first shared subset associated with UL transmissions and (ii) a second shared subset associated with DL transmissions.

At 1004, the UE activates one or more TCI states from a set of TCI states associated with the UL PC parameters in accordance with the at least one set of TCI states information. As an example, the activation may be performed by one or more of the component 198, the transceiver(s) 1122, and/or the antenna 1180 in FIG. 11. FIG. 5 illustrates, in the context of FIGS. 6, 7, 8, 9, an example of the UE 502 activating such TCI states/TCI codepoints associated with PC parameters.

The UE 502 may be configured to activate (at 508) (e.g., 699 in FIG. 6; 799 in FIG. 7; 899 in FIG. 8; 999 in FIG. 9) one or more TCI states from a set of TCI states associated with the UL PC parameters (e.g., 650, 652 in FIG. 6; 750, 752 in FIG. 7; 850, 852 in FIG. 8; 950, 952 in FIG. 9) in accordance with the at least one set of TCI states information (e.g., 606, 608, 610, 612 in FIG. 6; 708, 710, 711, 712, 713 in FIG. 7; 808, 810 in FIG. 8; 908, 910 in FIG. 9). The activation (at 508) (e.g., 699 in FIG. 6; 799 in FIG. 7; 899 in FIG. 8; 999 in FIG. 9) may be performed by the UE 502 in accordance with at least one set of TCI states information (e.g., which may include and/or be indicative of the set of UL PC parameters (e.g., 650, 652 in FIG. 6; 750, 752 in FIG. 7; 850, 852 in FIG. 8; 950, 952 in FIG. 9) associated with the SBFD operational mode and/or with the non-SBFD operational mode (e.g., 606, 608, 610, 612 in FIG. 6; 708, 710, 711, 712, 713 in FIG. 7; 808, 810 in FIG. 8; 908, 910 in FIG. 9). In aspects, the UE 502 may be configured to activate (at 508) (e.g., 699 in FIG. 6; 799 in FIG. 7; 899 in FIG. 8; 999 in FIG. 9) the one or more TCI states from the set of TCI states (e.g., 620, 624 in FIG. 6; 718 in FIG. 7; 818, 824 in FIG. 8; 918, 922 in FIG. 9) associated with the UL PC parameters (e.g., 650, 652 in FIG. 6; 750, 752 in FIG. 7; 850, 852 in FIG. 8; 950, 952 in FIG. 9) based on, and/or including, being configured to receive, e.g., from the base station 504 (e.g., a network node), a MAC-CE (e.g., 614, 616 in FIG. 6; 714 in FIG. 7; 812, 814 in FIG. 8; 912, 914 in FIG. 9) associated with the TCI configuration 506 (e.g., 698 in FIG. 6; 798 in FIG. 7; 898 in FIG. 8; 998 in FIG. 9).

In some aspects, the MAC-CE (e.g., 614, 616 in FIG. 6; 714 in FIG. 7; 812, 814 in FIG. 8; 912, 914 in FIG. 9) may include a 1-bit duplex set indication that is indicative of the one or more TCI states from of the set of TCI states (e.g., 620, 624 in FIG. 6; 718 in FIG. 7; 818, 824 in FIG. 8; 918, 922 in FIG. 9) activated for the SBFD operational mode or the non-SBFD operational mode. In such aspects, the UE 502 may also be configured to receive, as a part of the TCI configuration 506 (e.g., 698 in FIG. 6; 798 in FIG. 7; 898 in FIG. 8; 998 in FIG. 9) and/or of the activation (at 508) (e.g., 699 in FIG. 6; 799 in FIG. 7; 899 in FIG. 8; 999 in FIG. 9), DCI (e.g., 628 in FIG. 6; 928 in FIG. 9) indicative of the SBFD operational mode or the non-SBFD operational mode indicative of the one or more TCI states from the set of active TCI states associated with an indicated operational mode and/or of the activating. The DCI (e.g., 628 in FIG. 6; 928 in FIG. 9) may be indicative of the SBFD operational mode or the non-SBFD operational mode in accordance with an SBFD symbol type or a non-SBFD symbol type that comprises the DCI (e.g., 628 in FIG. 6; 928 in FIG. 9). The DCI (e.g., 628 in FIG. 6; 928 in FIG. 9) may be indicative of the SBFD operational mode or the non-SBFD operational mode in accordance with a duplex type (e.g., 820, 826 in FIG. 8) of a symbol or a slot of at least one of (i) PDSCH scheduled by the DCI or (ii) a PUCCH (e.g., 630 in FIG. 6) triggered by the DCI (e.g., 628 in FIG. 6; 928 in FIG. 9) that includes HARQ-ACK/NACK information. The DCI (e.g., 628 in FIG. 6; 928 in FIG. 9) may be indicative of the SBFD operational mode or the non-SBFD operational mode in accordance with a duplex indication that is indicative of (i) a 1-bit indication of the non-SBFD operational mode or the SBFD operational mode or (ii) multiple 1-bit indications (e.g., two 1-bit indications) of at least one of the non-SBFD operational mode or the SBFD operational mode.

In some aspects, the MAC-CE (e.g., 614, 616 in FIG. 6; 714 in FIG. 7; 812, 814 in FIG. 8; 912, 914 in FIG. 9) may be indicative of, and/or include, first subset of the set of TCI codepoints and a second subset of the set of TCI codepoints (e.g., 618, 622 in FIG. 6; 716 in FIG. 7; 816, 822 in FIG. 8; 916, 920 in FIG. 9) for at least one of the SBFD operational mode or the non-SBFD operational mode. In aspects, the first subset of the set of TCI codepoints (e.g., 618, 622 in FIG. 6; 716 in FIG. 7; 816, 822 in FIG. 8; 916, 920 in FIG. 9) may include a number of TCI codepoints (e.g., at most eight TCI codepoints) associated with the UL PC parameters (e.g., 650, 652 in FIG. 6; 750, 752 in FIG. 7; 850, 852 in FIG. 8; 950, 952 in FIG. 9) and the second subset of the set of TCI codepoints (e.g., 618, 622 in FIG. 6; 716 in FIG. 7; 816, 822 in FIG. 8; 916, 920 in FIG. 9) may include a number of TCI codepoints (e.g., at most eight TCI codepoints) associated with the UL PC parameters (e.g., 650, 652 in FIG. 6; 750, 752 in FIG. 7; 850, 852 in FIG. 8; 950, 952 in FIG. 9). In aspects, at least one TCI code point of the set of TCI codepoints (e.g., 618, 622 in FIG. 6; 716 in FIG. 7; 816, 822 in FIG. 8; 916, 920 in FIG. 9) may be associated with at least one of the SBFD operational mode, the non-SBFD operational mode, or both of the SBFD operational mode and the non-SBFD operational mode.

In some aspects, the MAC-CE (e.g., 614, 616 in FIG. 6; 714 in FIG. 7; 812, 814 in FIG. 8; 912, 914 in FIG. 9) may be indicative of, and/or include, an indication, for each codepoint of the set of TCI codepoints (e.g., 618, 622 in FIG. 6; 716 in FIG. 7; 816, 822 in FIG. 8; 916, 920 in FIG. 9), of one or more of (i) at least one associated TCI state of the set of TCI states (e.g., 620, 624 in FIG. 6; 718 in FIG. 7; 818, 824 in FIG. 8; 918, 922 in FIG. 9) or (ii) at least one of the SBFD operational mode or the non-SBFD operational mode associated with each codepoint.

In some aspects, the MAC-CE (e.g., 614, 616 in FIG. 6; 714 in FIG. 7; 812, 814 in FIG. 8; 912, 914 in FIG. 9) may be indicative of, and/or include, an indication, for each codepoint of the set of TCI codepoints (e.g., 618, 622 in FIG. 6; 716 in FIG. 7; 816, 822 in FIG. 8; 916, 920 in FIG. 9), of at least one associated TCI state of the set of TCI states (e.g., 620, 624 in FIG. 6; 718 in FIG. 7; 818, 824 in FIG. 8; 918, 922 in FIG. 9). In such aspects, the UE 502 may also be configured to receive, as a part of the TCI configuration 506 (e.g., 698 in FIG. 6; 798 in FIG. 7; 898 in FIG. 8; 998 in FIG. 9) and/or of the activation (at 508) (e.g., 699 in FIG. 6; 799 in FIG. 7; 899 in FIG. 8; 999 in FIG. 9), DCI (e.g., 628 in FIG. 6; 928 in FIG. 9) indicative of at least one of the SBFD operational mode or the non-SBFD operational mode for each associated TCI state of each codepoint of the set of TCI codepoints (e.g., 618, 622 in FIG. 6; 716 in FIG. 7; 816, 822 in FIG. 8; 916, 920 in FIG. 9). In aspects, each codepoint of the set of TCI codepoints (e.g., 618, 622 in FIG. 6; 716 in FIG. 7; 816, 822 in FIG. 8; 916, 920 in FIG. 9) may include at most two associated TCI states, and the DCI (e.g., 628 in FIG. 6; 928 in FIG. 9) may include a 1-bit indication (e.g., 930 in FIG. 9) of the at least one of the SBFD operational mode or the non-SBFD operational mode for each TCI state of the at most two associated TCI states. In aspects, each codepoint of the set of TCI codepoints (e.g., 618, 622 in FIG. 6; 716 in FIG. 7; 816, 822 in FIG. 8; 916, 920 in FIG. 9) may include at most four associated TCI states, and the DCI (e.g., 628 in FIG. 6; 928 in FIG. 9) may include a bitmap (e.g., 932 in FIG. 9) indication of the at least one of the SBFD operational mode or the non-SBFD operational mode for each TCI state of the at most four associated TCI states.

As described herein, any receptions and/or activations associated with the TCI configuration 506 (e.g., 698 in FIG. 6; 798 in FIG. 7; 898 in FIG. 8; 998 in FIG. 9) and/or the set of TCI states (e.g., 620, 624 in FIG. 6; 718 in FIG. 7; 818, 824 in FIG. 8; 918, 922 in FIG. 9) and the set of TCI codepoints (e.g., 618, 622 in FIG. 6; 716 in FIG. 7; 816, 822 in FIG. 8; 916, 920 in FIG. 9) associated with the UL PC parameters (e.g., 650, 652 in FIG. 6; 750, 752 in FIG. 7; 850, 852 in FIG. 8; 950, 952 in FIG. 9) (activation at 508) (e.g., 699 in FIG. 6; 799 in FIG. 7; 899 in FIG. 8; 999 in FIG. 9) may occur prior to, subsequent to, and/or at least partially concurrently with any other receptions and/or activations at/by the UE 502. For instance, in some aspects, an activation (at 508) (e.g., 699 in FIG. 6; 799 in FIG. 7; 899 in FIG. 8; 999 in FIG. 9) may also comprise, at least in part, a reception associated with the TCI configuration 506 (e.g., 698 in FIG. 6; 798 in FIG. 7; 898 in FIG. 8; 998 in FIG. 9); likewise, in some aspects, an activation (at 508) (e.g., 699 in FIG. 6; 799 in FIG. 7; 899 in FIG. 8; 999 in FIG. 9) may also comprise, at least in part, a reception associated with the TCI configuration 506 (e.g., 698 in FIG. 6; 798 in FIG. 7; 898 in FIG. 8; 998 in FIG. 9).

At 1006, the UE transmits, to the network node via a set of beams associated with the activated one or more TCI states, UL messages in accordance with an UL PC parameter of a TCI state that is based on the set of TCI states. As an example, the transmission may be performed by one or more of the component 198, the transceiver(s) 1122, and/or the antenna 1180 in FIG. 11. FIG. 5 illustrates, in the context of FIGS. 6, 7, 8, 9, an example of the UE 502 transmitting such UL messages to a network node (e.g., the base station 504).

The UE 502 may be configured to transmit/provide, and the base station 504 may be configured to receive, e.g., via a set of beams (e.g., 638 in FIG. 6; 924 in FIG. 9), UL messages 510 in accordance a UL PC parameter of a TCI state. The UL PC parameter of the TCI state for transmission of the UL messages 510 may be based on the set of TCI states (e.g., 620, 624 in FIG. 6; 718 in FIG. 7; 818, 824 in FIG. 8; 918, 922 in FIG. 9) and the set of TCI codepoints (e.g., 618, 622 in FIG. 6; 716 in FIG. 7; 816, 822 in FIG. 8; 916, 920 in FIG. 9) configured via the TCI configuration 506 (e.g., 698 in FIG. 6; 798 in FIG. 7; 898 in FIG. 8; 998 in FIG. 9). In aspects, the UE 502 may be configured to receive, and the base station 504 may be configured to transmit/provide, e.g., via a set of beams (e.g., 638 in FIG. 6; 924 in FIG. 9), DL signals described herein, in accordance a UL PC parameter of a TCI state that may also be based on the set of TCI states (e.g., 620, 624 in FIG. 6; 718 in FIG. 7; 818, 824 in FIG. 8; 918, 922 in FIG. 9) and the set of TCI codepoints (e.g., 618, 622 in FIG. 6; 716 in FIG. 7; 816, 822 in FIG. 8; 916, 920 in FIG. 9) configured via the TCI configuration 506 (e.g., 698 in FIG. 6; 798 in FIG. 7; 898 in FIG. 8; 998 in FIG. 9). That is, the UE 502 and the base station 504 (e.g., a network node, generally) may be configured to communicate via signaling using beams (e.g., 638 in FIG. 6; 924 in FIG. 9) based on a UL PC parameter of a TCI state associated with the set of TCI states (e.g., 620, 624 in FIG. 6; 718 in FIG. 7; 818, 824 in FIG. 8; 918, 922 in FIG. 9) and the set of TCI codepoints (e.g., 618, 622 in FIG. 6; 716 in FIG. 7; 816, 822 in FIG. 8; 916, 920 in FIG. 9) configured via the TCI configuration 506 (e.g., 698 in FIG. 6; 798 in FIG. 7; 898 in FIG. 8; 998 in FIG. 9).

Aspects herein provide that such transmissions (e.g., the UL messages 510), receptions, and/or communications may be based on duplex-specific UL PC parameters (e.g., 650, 652 in FIG. 6; 750, 752 in FIG. 7; 850, 852 in FIG. 8; 950, 952 in FIG. 9) (e.g., different UL PC parameters for signaling in an SBFD operational mode than signaling in a non-SBFD operational mode). In other words, TCI states may be configured with a single UL PC parameter, in various embodiments.

Accordingly, separate, joint, and/or shared sets of configured and/or activated TCI states and associated TCI codepoints, per duplex type (e.g., for SBFD and also for non-SBFD), are enabled by aspects herein.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive, from a network node, a TCI configuration indicative of at least one set of TCI states information, where each TCI state in the at least one set of TCI states information includes UL PC parameters associated with a SBFD operational mode or with a non-SBFD operational mode. The component 198 may be configured to activate one or more TCI states from a set of TCI states associated with the UL PC parameters in accordance with the at least one set of TCI states information. The component 198 may be configured to transmit, to the network node via a set of beams associated with the activated one or more TCI states, UL messages in accordance with an UL PC parameter of a TCI state that is based on the set of TCI states. The component 198 may be further configured to perform any of the aspects described in connection with the flowcharts in of FIG. 10, and/or any of the aspects performed by a UE for any of FIGS. 4-9. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a network node, a TCI configuration indicative of at least one set of TCI states information, where each TCI state in the at least one set of TCI states information includes UL PC parameters associated with a SBFD operational mode or with a non-SBFD operational mode. In one configuration, the apparatus 1104, and in particular the cellular baseband processor(s) 1124 and/or the application processor(s) 1106, may include means for activating one or more TCI states from a set of TCI states associated with the UL PC parameters in accordance with the at least one set of TCI states information. In one configuration, the apparatus 1104, and in particular the cellular baseband processor(s) 1124 and/or the application processor(s) 1106, may include means for transmitting, to the network node via a set of beams associated with the activated one or more TCI states, UL messages in accordance with an UL PC parameter of a TCI state that is based on the set of TCI states. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

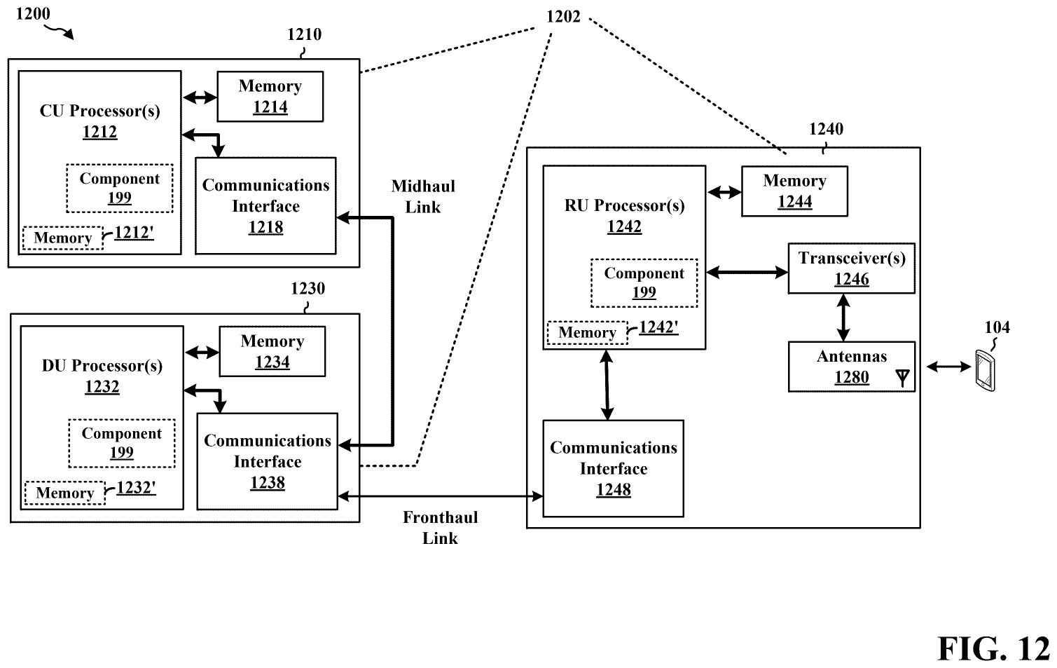

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with a TCI configuration indicative of at least one set of TCI states information, where the at least one set of TCI states information includes UL PC parameters associated with a SBFD operational mode or with a non-SBFD operational mode. The component 199 may be configured to receive, from the UE via a set of beams and subsequent to activation of one or more TCI states from a set of TCI states associated with the UL PC parameters, UL messages in accordance with an UL PC parameter of a TCI state that is based on the set of TCI states. The component 199 may be further configured to perform any of the aspects described in connection with the flowcharts in any of FIGS. 9, 10, and/or any of the aspects performed by a network node (e.g., a base station, a gNB, a network entity, etc.) for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for configuring a UE with a TCI configuration indicative of at least one set of TCI states information, where the at least one set of TCI states information includes UL PC parameters associated with a SBFD operational mode or with a non-SBFD operational mode. In one configuration, the network entity 1202 may include means for receiving, from the UE via a set of beams and subsequent to activation of one or more TCI states from a set of TCI states associated with the UL PC parameters, UL messages in accordance with an UL PC parameter of a TCI state that is based on the set of TCI states. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A UE may be configured by a network node for unified TCI states to be utilized in communications. As an example, a RRC configuration from a network node indicates whether the unified TCI is for joint DL/UL or separate UL/DL TCI states. Subsequently, a MAC-CE activates unified TCI states and indicates whether the TCI codepoint has two TCI states, e.g., separate UL/DL TCI, or single TCI states, e.g., joint UL/DL TCI, UL-only UL/DL TCI, or DL-only UL/DL TCI. Downlink control information (DCI) format 1_1/1_2 has TCI states that indicate these “sticky” TCI codepoints. PC parameters are configured per the TCI-state definition (e.g., have separate instances for configurations in UL-only or joint UL/DL TCI) and include PL-RS and PC parameters (e.g., Po, alpha, closed-loop index, and/or the like). The PC parameters may be configured for signaling in a PUSCH, PUCCH, SRS, etc. However, current TCI state configurations lack support of separate UL power control for PUSCH, PUCCH, SRS, etc., transmissions in SBFD symbols and non-SBFD symbols. That is, while solutions provide for unified TCI state frameworks, as noted above, such frameworks do not enable a network node to configure a UE for duplex-specific power control for such unified TCI frameworks. Accordingly, nor do current solutions enable the configuration of a UE with separate PC parameters for duplex-specific power control.

Aspects herein for duplex-specific power control for a unified TCI framework provide UE configurations that enable solutions to such issues, and accordingly, separate, joint, and/or shared sets of configured and/or activated TCI states and associated TCI codepoints, per duplex type, are enabled by aspects herein. Aspects enable separate UL power control in SBFD symbols and in non-SBFD symbols by providing TCI configurations for duplex-specific power control. Aspects enable duplex-specific power control for a unified TCI framework in different operating scenarios by enabling flexibility in such TCI configurations for duplex-specific power control. Aspects also enable the configuration of a UE with separate PC parameters by providing duplex-specific indications in a MAC-CE and/or DCI.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, a transmission configuration indication (TCI) configuration indicative of at least one set of TCI states information, wherein each TCI state in the at least one set of TCI states information includes uplink (UL) power control (PC) parameters associated with a sub-band (SB) full duplex (SBFD) operational mode or with a non-SBFD operational mode; activating one or more TCI states from a set of TCI states associated with the UL PC parameters in accordance with the at least one set of TCI states information; and transmitting, to the network node via a set of beams associated with the activated one or more TCI states, UL messages in accordance with an UL PC parameter of a TCI state that is based on the set of TCI states.

Aspect 2 is the method of aspect 1, wherein the at least one set of TCI states information is indicative of, for at least one bandwidth part (BWP) of the UE, at least one of: (i) a first set of TCI states information, associated with the SBFD operational mode, that includes SBFD UL PC parameters or (ii) a second set of TCI states information, associated with the non-SBFD operational mode, that includes non-SBFD UL PC parameters.

Aspect 3 is the method of aspect 2, wherein receiving the TCI configuration indicative of the at least one set of TCI states information includes receiving the TCI configuration via radio resource control (RRC) signaling; and wherein activating the one or more TCI states from the set of TCI states associated with the UL PC parameters includes: receiving, via a medium access control (MAC) control element (MAC-CE), a 1-bit duplex set indication that is indicative of the one or more TCI states from of the set of TCI states activated for the SBFD operational mode or the non-SBFD operational mode.

Aspect 4 is the method of aspect 3, wherein activating the one or more TCI states from the set of TCI states associated with the UL PC parameters includes: receiving downlink control information (DCI) indicative of the SBFD operational mode or the non-SBFD operational mode and indicative of the one or more TCI states from the set of active TCI states associated with an indicated operational mode.

Aspect 5 is the method of aspect 4, wherein the DCI is indicative of the SBFD operational mode or the non-SBFD operational mode in accordance with an SBFD symbol type or a non-SBFD symbol type that comprises the DCI.

Aspect 6 is the method of any of aspects 4 and 5, wherein the DCI is indicative of the SBFD operational mode or the non-SBFD operational mode in accordance with a duplex type of a symbol or a slot of at least one of (i) physical downlink shared channel (PDSCH) scheduled by the DCI or (ii) physical uplink control channel (PUCCH) triggered by the DCI that includes hybrid automatic repeat request (HARQ)-acknowledgement (ACK)/negative acknowledgement (NACK) (HARQ-ACK/NACK) information of the scheduled PDSCH.

Aspect 7 is the method of any of aspects 4 to 6, wherein the DCI is indicative of the SBFD operational mode or the non-SBFD operational mode in accordance with a duplex indication that is indicative of (i) a 1-bit indication of the non-SBFD operational mode or the SBFD operational mode or (ii) multiple 1-bit indications of at least one of the non-SBFD operational mode or the SBFD operational mode.

Aspect 8 is the method of aspect 1, wherein the at least one set of TCI states information is indicative of, for at least one bandwidth part (BWP) of the UE, a joint set of TCI states information that comprises (i) a first joint subset associated with the SBFD operational mode that includes an SBFD UL PC parameter for each TCI in the first subset and (ii) a second joint subset associated with the non-SBFD operational mode that includes a non-SBFD UL PC parameter for each TCI in the second subset.

Aspect 9 is the method of aspect 8, wherein receiving the TCI configuration indicative of the at least one set of TCI states information includes receiving the TCI configuration via radio resource control (RRC) signaling, wherein (i) the first joint subset comprises a first half of the joint set of TCI states information and the second joint subset comprises a second half of the joint set of TCI states information or (ii) the TCI configuration includes RRC parameter that indicative of a downlink (DL)/joint TCI indication or an UL TCI indication is associated with the SBFD operational mode or the non-SBFD operational mode or both modes for the joint set of TCI states information, wherein the RRC signaling indicates an increase of a maximum number of TCI states in the set of TCI states.

Aspect 10 is the method of aspect 9, wherein activating the one or more TCI states from the set of TCI states associated with the UL PC parameters includes: receiving, via a medium access control (MAC) control element (MAC-CE), a first subset of a set of TCI codepoints and a second subset of the set of TCI codepoints for at least one of the SBFD operational mode or the non-SBFD operational mode.

Aspect 11 is the method of any of aspects 9 and 10, wherein the SBFD operational mode and the non-SBFD operational mode have a same unified TCI type.

Aspect 12 is the method of any of aspects 9 to 11, wherein a first subset of a set of TCI codepoints, associated with the UL PC parameters, includes at most eight TCI codepoints and a second subset of the set of TCI codepoints, associated with the UL PC parameters, includes at most eight TCI codepoints.

Aspect 13 is the method of any of aspects 9 to 12, wherein at least one TCI codepoint of a set of TCI codepoints is associated with at least one of the SBFD operational mode, the non-SBFD operational mode, or both of the SBFD operational mode and the non-SBFD operational mode.

Aspect 14 is the method of aspect 1, wherein the at least one set of TCI states information is indicative of, for at least one bandwidth part (BWP) of the UE, a shared set of TCI states information for the SBFD operational mode and the non-SBFD operational mode that comprises (i) a first shared subset associated with UL transmissions and (ii) a second shared subset associated with DL transmissions.

Aspect 15 is the method of aspect 14, wherein receiving the TCI configuration indicative of the at least one set of TCI states information includes receiving the TCI configuration via radio resource control (RRC) signaling; wherein activating the one or more TCI states from the set of TCI states associated with the UL PC parameters includes: receiving, via a medium access control (MAC) control element (MAC-CE), an indication, for each codepoint of a set of TCI codepoints, of one or more of: (i) at least one associated TCI state of the set of TCI states and (ii) at least one of the SBFD operational mode or the non-SBFD operational mode associated with each codepoint or each TCI state in the set of TCI codepoints.

Aspect 16 is the method of any of aspects 14 and 15, wherein receiving the TCI configuration indicative of the at least one set of TCI states information includes receiving the TCI configuration via radio resource control (RRC) signaling; wherein activating the one or more TCI states from the set of TCI states associated with the UL PC parameters includes: receiving, via a medium access control (MAC) control element (MAC-CE), an indication, for each codepoint of a set of TCI codepoints, of at least one associated TCI state of the set of TCI states; and receiving downlink control information (DCI) indicative of at least one of the SBFD operational mode or the non-SBFD operational mode for each associated TCI state of each codepoint.

Aspect 17 is the method of aspect 16, wherein each codepoint of the set of TCI codepoints includes at most two associated TCI states, where the DCI includes a 1-bit indication of the at least one of the SBFD operational mode or the non-SBFD operational mode for each TCI state of the at most two associated TCI states.

Aspect 18 is the method of aspect 16, wherein each codepoint of the set of TCI codepoints includes at most four associated TCI states, where the DCI includes a bitmap indication of the at least one of the SBFD operational mode or the non-SBFD operational mode for each TCI state of the at most four associated TCI states.

Aspect 19 is an apparatus for wireless communication at a user equipment (UE), comprising: at least one memory; and at least one processor coupled to the at least one memory, the at least one processor, individually or in any combination, is configured to perform the method of any of aspects 1 to 18.

Aspect 20 is an apparatus for wireless communication at a user equipment (UE), comprising means for performing each step in the method of any of aspects 1 to 18.

Aspect 21 is the apparatus of any of aspects 19 and 20, further comprising a transceiver configured to receive or to transmit in association with the method of any of aspects 1 to 18.

Aspect 22 is a computer-readable medium (e.g., a non-transitory computer-readable medium) storing computer executable code at a user equipment (UE), the code when executed by at least one processor causes the at least one processor to perform the method of any of aspects 1 to 18.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a transmission configuration indication (TCI) configuration indicative of at least one set of TCI states information, wherein each TCI state in the at least one set of TCI states information includes uplink (UL) power control (PC) parameters associated with a sub-band (SB) full duplex (SBFD) operational mode or with a non-SBFD operational mode;
activate one or more TCI states from a set of TCI states associated with the UL PC parameters in accordance with the at least one set of TCI states information; and
transmit, to the network node via a set of beams associated with the activated one or more TCI states, UL messages in accordance with an UL PC parameter of a TCI state that is based on the set of TCI states.

2. The apparatus of claim 1, wherein the at least one set of TCI states information is indicative of, for at least one bandwidth part (BWP) of the UE, at least one of: (i) a first set of TCI states information, associated with the SBFD operational mode, that includes SBFD UL PC parameters or (ii) a second set of TCI states information, associated with the non-SBFD operational mode, that includes non-SBFD UL PC parameters.

3. The apparatus of claim 2, wherein to receive the TCI configuration indicative of the at least one set of TCI states information, the at least one processor, individually or in any combination, is configured to receive the TCI configuration via radio resource control (RRC) signaling; and
wherein to activate the one or more TCI states from the set of TCI states associated with the UL PC parameters, the at least one processor, individually or in any combination, is configured to:
receive, via a medium access control (MAC) control element (MAC-CE), a 1-bit duplex set indication that is indicative of the one or more TCI states from of the set of TCI states activated for the SBFD operational mode or the non-SBFD operational mode.

4. The apparatus of claim 3, wherein to activate the one or more TCI states from the set of TCI states associated with the UL PC parameters, the at least one processor, individually or in any combination, is configured to:
receive downlink control information (DCI) indicative of the SBFD operational mode or the non-SBFD operational mode and indicative of the one or more TCI states from the set of active TCI states associated with an indicated operational mode.

5. The apparatus of claim 4, wherein the DCI is indicative of the SBFD operational mode or the non-SBFD operational mode in accordance with an SBFD symbol type or a non-SBFD symbol type that comprises the DCI.

6. The apparatus of claim 4, wherein the DCI is indicative of the SBFD operational mode or the non-SBFD operational mode in accordance with a duplex type of a symbol or a slot of at least one of (i) physical downlink shared channel (PDSCH) scheduled by the DCI or (ii) physical uplink control channel (PUCCH) triggered by the DCI that includes hybrid automatic repeat request (HARQ)-acknowledgement (ACK)/negative acknowledgement (NACK) (HARQ-ACK/NACK) information of the scheduled PDSCH.

7. The apparatus of claim 4, wherein the DCI is indicative of the SBFD operational mode or the non-SBFD operational mode in accordance with a duplex indication that is indicative of (i) a 1-bit indication of the non-SBFD operational mode or the SBFD operational mode or (ii) multiple 1-bit indications of at least one of the non-SBFD operational mode or the SBFD operational mode.

8. The apparatus of claim 1, wherein the at least one set of TCI states information is indicative of, for at least one bandwidth part (BWP) of the UE, a joint set of TCI states information that comprises (i) a first joint subset associated with the SBFD operational mode that includes an SBFD UL PC parameter for each TCI in the first subset and (ii) a second joint subset associated with the non-SBFD operational mode that includes a non-SBFD UL PC parameter for each TCI in the second subset.

9. The apparatus of claim 8, wherein to receive the TCI configuration indicative of the at least one set of TCI states information, the at least one processor, individually or in any combination, is configured to receive the TCI configuration via radio resource control (RRC) signaling;
wherein (i) the first joint subset comprises a first half of the joint set of TCI states information and the second joint subset comprises a second half of the joint set of TCI states information or (ii) the TCI configuration includes an RRC parameter indicative of a downlink (DL)/joint TCI indication or an UL TCI indication associated with the SBFD operational mode or the non-SBFD operational mode or both modes for the joint set of TCI states information, wherein the RRC signaling indicates an increase of a maximum number of TCI states in the set of TCI states.

10. The apparatus of claim 9, wherein to activate the one or more TCI states from the set of TCI states associated with the UL PC parameters, the at least one processor, individually or in any combination, is configured to:
receive, via a medium access control (MAC) control element (MAC-CE), a first subset of a set of TCI codepoints and a second subset of the set of TCI codepoints for at least one of the SBFD operational mode or the non-SBFD operational mode.

11. The apparatus of claim 9, wherein the SBFD operational mode and the non-SBFD operational mode have a same unified TCI type.

12. The apparatus of claim 9, wherein a first subset of a set of TCI codepoints, associated with the UL PC parameters, includes at most eight TCI codepoints and a second subset of the set of TCI codepoints, associated with the UL PC parameters, includes at most eight TCI codepoints.

13. The apparatus of claim 9, wherein at least one TCI code point of a set of TCI codepoints is associated with at least one of the SBFD operational mode, the non-SBFD operational mode, or both of the SBFD operational mode and the non-SBFD operational mode.

14. The apparatus of claim 1, wherein the at least one set of TCI states information is indicative of, for at least one bandwidth part (BWP) of the UE, a shared set of TCI states information for the SBFD operational mode and the non-SBFD operational mode that comprises (i) a first shared subset associated with UL transmissions and (ii) a second shared subset associated with DL transmissions.

15. The apparatus of claim 14, further comprising at least one transceiver coupled to the at least one processor;
wherein to receive the TCI configuration indicative of the at least one set of TCI states information, the at least one processor, individually or in any combination, is configured to receive the TCI configuration via radio resource control (RRC) signaling and the at least one transceiver;
wherein to activate the one or more TCI states from the set of TCI states associated with the UL PC parameters, the at least one processor, individually or in any combination, is configured to:
receive, via a medium access control (MAC) control element (MAC-CE), an indication, for each codepoint of a set of TCI codepoints, of one or more of: (i) at least one associated TCI state of the set of TCI states and (ii) at least one of the SBFD operational mode or the non-SBFD operational mode associated with each codepoint or each TCI state in the set of TCI codepoints.

16. The apparatus of claim 14, wherein to receive the TCI configuration indicative of the at least one set of TCI states information, the at least one processor, individually or in any combination, is configured to receive the TCI configuration via radio resource control (RRC) signaling;
wherein to activate the one or more TCI states from the set of TCI states associated with the UL PC parameters, the at least one processor, individually or in any combination, is configured to:
receive, via a medium access control (MAC) control element (MAC-CE), an indication, for each codepoint of a set of TCI codepoints, of at least one associated TCI state of the set of TCI states; and
receive downlink control information (DCI) indicative of at least one of the SBFD operational mode or the non-SBFD operational mode for each associated TCI state of each codepoint.

17. The apparatus of claim 16, wherein each codepoint of the set of TCI codepoints includes at most two associated TCI states, where the DCI includes a 1-bit indication of the at least one of the SBFD operational mode or the non-SBFD operational mode for each TCI state of the at most two associated TCI states.

18. The apparatus of claim 16, wherein each codepoint of the set of TCI codepoints includes at most four associated TCI states, where the DCI includes a bitmap indication of the at least one of the SBFD operational mode or the non-SBFD operational mode for each TCI state of the at most four associated TCI states.

19. A method of wireless communication at a user equipment (UE), comprising:
receiving, from a network node, a transmission configuration indication (TCI) configuration indicative of at least one set of TCI states information, wherein each TCI state in the at least one set of TCI states information includes uplink (UL) power control (PC) parameters associated with a sub-band (SB) full duplex (SBFD) operational mode or with a non-SBFD operational mode;
activating one or more TCI states from a set of TCI states associated with the UL PC parameters in accordance with the at least one set of TCI states information; and
transmitting, to the network node via a set of beams associated with the activated one or more TCI states, UL messages in accordance with an UL PC parameter of a TCI state that is based on the set of TCI states.

20. A computer-readable medium storing computer executable code at a user equipment (UE), the code when executed by at least one processor causes the at least one processor to:
receive, from a network node, a transmission configuration indication (TCI) configuration indicative of at least one set of TCI states information, wherein each TCI state in the at least one set of TCI states information includes uplink (UL) power control (PC) parameters associated with a sub-band (SB) full duplex (SBFD) operational mode or with a non-SBFD operational mode;
activate one or more TCI states from a set of TCI states associated with the UL PC parameters in accordance with the at least one set of TCI states information; and
transmit, to the network node via a set of beams associated with the activated one or more TCI states, UL messages in accordance with an UL PC parameter of a TCI state that is based on the set of TCI states.
